(19) United States
(12) Patent Application Publication
(10) Pub. No.: US 2024/0078493 A1
(43) Pub. Date: Mar. 7, 2024

(54) VENDOR MONITORING SYSTEM AND METHODOLOGY

(71) Applicant: Venminder, Inc., Elizabethtown, KY (US)

(72) Inventor: Dana A. Bowers, Elizabethtown, KY (US)

(21) Appl. No.: 18/462,336

(22) Filed: Sep. 6, 2023

Related U.S. Application Data
(60) Provisional application No. 63/404,506, filed on Sep. 7, 2022.

(51) Int. Cl. G06Q 10/0635

(52) U.S. Cl. CPC G06Q 10/0635

(57) ABSTRACT

A vendor monitoring system includes: a vendor monitoring portal identifying at least one vendor of interest; at least one data partner portal communicatively coupled to the vendor monitoring portal and controlled by a third party data partner, the data partner portal providing at least one risk rating to the vendor monitoring portal, risk rating associated with the vendor of interest.

### CROSS-REFERENCE TO RELATED APPLICATIONS

This application claims priority to U.S. Provisional Patent Application No. 63/404,506, filed Sep. 7, 2022, entitled “Vendor Monitoring System and Methodology,” the content of which is incorporated herein by reference in its entirety.

### BACKGROUND

Financial institutions such as banks and credit unions are increasingly relying on third-party vendors to perform various important functions. While this improves efficiency and reduces cost for the financial institution, there are various risks posed by such outsourcing. A financial institution (“FI”) must establish a vendor oversight program to mitigate such risks, comply with various regulations, and pass examination by auditors. Generally, maintaining oversight of different vendors and vendor products requires a coordination of large amounts of oversight requirements, tasks, documents, results, due dates, and individuals.

The vendor management process has historically been disjointed, messy, and time-consuming. A single financial institution may have numerous vendors to manage, and there may be many individuals within a given financial institution who deal with a given vendor and must coordinate collection of documents and data regarding the corresponding vendor products. Furthermore, the terms of various contracts between a financial institution and its vendors must be carefully monitored.

Moreover, financial institutions may wish to maintain different types of information about the vendors and vendor products with which they are associated. Traditional vendor management systems allow financial institutions to maintain information according to a predetermined set of fields. Handling multiple vendor contracts, products, workflows, payment requests, oversight tasks, and other tasks individually gets cumbersome, even when working with only a single vendor. Managing multiple vendors can make an already challenging task orders or magnitude more difficult.

### SUMMARY

Methods and systems are presented herein for adding, to a vendor management system, information relating to one or more (new) vendors providing services and/or other products to a client (for example, financial institution, as well as any other institution that does business with vendors, suppliers, third parties, etc. that is interested in assessing the risk associated with the vendor or third party in question). In some embodiments, the disclosed methods and systems may be used in connection with the vendor management system (for example, in connection with a vendor monitoring portal) to access data from third party data partners (i.e., data providers, i.e., data aggregators) that provide risk assessments based on different aspects of risk. In some embodiments, the disclosed methods and systems may be used to aggregate risk data from different data partners to arrive at a single risk rating for a given vendor, the single risk rating incorporating all of the various aspects of risk from the multiple data providers.

In one aspect, the invention is directed to a method and/or system for monitoring vendors including: a vendor monitoring portal identifying at least one vendor of interest; at least one data partner portal communicatively coupled to the vendor monitoring portal and controlled by a third party data partner, the data partner portal providing at least one risk rating to the vendor monitoring portal, the risk rating associated with the vendor of interest. In some embodiments, the vendor monitoring portal normalizes and aggregates data from multiple data partners to arrive at a single overall risk rating for the vendor of interest.

In some embodiments, multiple data partners, wherein each data partner provides at least one risk rating associated with the vendor of interest to the vendor monitoring portal.

In some embodiments, each data partner provides a risk assessment based on at least one aspect of risk, the at least one aspect of risk comprising cybersecurity, privacy, business health, negative news, dark web risks, and/or environmental, social, and/or governance (ESG).

In some embodiments, the multiple data partners provide risk assessments to the vendor monitoring based on cybersecurity, privacy, business health, and negative news.

In some embodiments, the vendor monitoring portal is deep-linked to the data partner portal.

In some embodiments, the vendor monitoring portal communicates with the data partner portal via at least one application programmable interface (API).

In some embodiments, data from each data partner, once received by the vendor monitoring portal, is normalized to a standard risk rating scale.

In some embodiments, the data from each data partner, once normalized, is aggregated to arrive at a single overall risk rating for the vendor of interest.

In some embodiments, the data from each data partner, once normalized, is aggregated via arithmetic averaging to arrive at the single overall risk rating for the vendor of interest.

In some embodiments, the vendor monitoring portal accesses data from about 4 to about 10 data partners, and the vendor monitoring portal accesses data from the each of the data partners once every 24 hours.

In some embodiments, the vendor monitoring portal accesses cybersecurity risk data from more than one data partner.

In another aspect, the present embodiments are directed to a method of reconstructing an original shape of third party data, the method comprising: accessing, by a client within a single portal, the third party data via an API call to the third party; identifying a shape of the third party data; transforming the third party data into serialized data pairs; porting the serialized data pairs to a relational database, the relational database being remote from the third party; and reconstructing the third party data in the original shape within at least one client graphical user interface (GUI).

In some embodiments, the method includes displaying the third party data in the original shape within the at least one client GUI within the single portal.

In some embodiments, reconstructing an original shape of third party data comprises reconstructing respective original shapes of data from multiple third parties, the method further comprising normalizing data from the multiple third parties to a standardized numerical rating scale.

In some embodiments, identifying a shape of the third party data comprises performing field recognition within an API of the third party.

In some embodiments, transforming the third party data into serialized data pairs comprises concatenating the third party data with at least one location identifier and at least one separator into a single string.

In some embodiments, reconstructing the third party data in the original shape comprises parsing the serialized data pairs into a series of substrings comprising at least one original data point from the third party data and at least one location identifier.

In some embodiments, accessing, by a client within a single portal, the third party data comprises using, by the client, at least one sharable token.

In some embodiments, accessing, by a client within a single portal, the third party data comprises matching a first field of a client API to a second field of a third party API, and each of the first field and the second field comprises guaranteed unique evidence.

In some embodiments, the respective original shapes of data from multiple third parties comprises at least one third party data shape that is different from at least one other third party data shape; and transforming the third party data into serialized data pairs comprises transforming the third party data into JavaScript Object Notation (JSON) data format.

### BRIEF DESCRIPTION OF THE FIGURES

The foregoing and other objects, aspects, features, and advantages of the present disclosure will become more apparent and better understood by referring to the following description taken in conjunction with the accompanying drawings, in which:

FIG. 1 is a block diagram of an example system for managing contracts between a financial institution and its vendors.

FIG. 2 is a block diagram of the example system for managing contracts between the financial institution and its vendors, in accordance with an embodiment of the invention.

FIG. 3 is an example main dashboard, in accordance with an embodiment of the invention.

FIG. 4 is an example vendor dashboard, in accordance with an embodiment of the invention.

FIG. 5 is another example vendor dashboard in accordance with an embodiment of the invention.

FIG. 6 is an example vendor dashboard activation page, in accordance with an embodiment of the invention.

FIG. 7 is an example activation dialog box, in accordance with an embodiment of the invention.

FIG. 8 is an example activation dialog box, in accordance with an embodiment of the invention.

FIG. 9 is an example Venmonitor download page, in accordance with an embodiment of the invention.

FIG. 10 is an example Venmonitor history window, in accordance with an embodiment of the invention.

FIG. 11 is an example Venmonitor onboarding request, in accordance with an embodiment of the invention.

FIG. 12 is an example process flow illustrating API integrations, in accordance with an embodiment of the invention.

FIG. 13 is an example Venmonitor partner summary, in accordance with an embodiment of the invention.

FIG. 14 is an example of an overall vendor rating, in accordance with an embodiment of the invention.

FIG. 15 is an example of a drop-down window presenting user options, in accordance with an embodiment of the invention.

FIG. 16 is an example of a drop-down window presenting user options, in accordance with an embodiment of the invention.

FIG. 17 is an example of a drop-down window presenting user options, in accordance with an embodiment of the invention.

FIG. 18A is an example of a drop-down window presenting user options, in accordance with an embodiment of the invention.

FIG. 18B is an example of a using a client's existing data partner subscription to access the data partner data via Venmonitor, in accordance with an embodiment of the invention.

FIG. 19 is an example of a drop-down window presenting user options, in accordance with an embodiment of the invention.

FIG. 20 is an example order flow for the One-Time Executive Summary option, in accordance with an embodiment of the invention.

FIG. 21 is an example Executive Summary Template, in accordance with an embodiment of the invention.

FIG. 22 illustrate example Daily Refresh and One-Time summaries, in accordance with an embodiment of the invention.

FIG. 23 is an example One-Time Executive Summary, in accordance with an embodiment of the invention.

FIG. 24 is a block diagram of an example network environment for use in the methods and systems for analysis of spectrometry data, according to an illustrative embodiment.

FIG. 25 is a block diagram of an example computing device and an example mobile computing device, for use in illustrative embodiments of the invention.

FIG. 26 illustrates a method by which data of differing shapes can be extracted from data partners for storage and display in Venmonitor, according to aspects of the present embodiments.

The features and advantages of the present disclosure will become more apparent from the detailed description set forth below when taken in conjunction with the drawings, in which like reference characters identify corresponding elements throughout. In the drawings, like reference numbers generally indicate identical, functionally similar, and/or structurally similar elements.

### DEFINITIONS

Client: Organization that uses Venminder (or other equivalent) software.

Purchase Plan: Outlines the client's access to modules within the Venminder software.

Administrator: Client users that have access to the admin panel and system settings that ‘controls’ how the client's Venminder account functions.

Requestor: User who submitted the vendor offboarding request.

VMO: Vendor Management Office/Officer.

Workflows: Module provided by Venminder (or other software provider) that allows users to define and automate required activities or tasks using rule-based logic.

Vendor Offboarding: Module provided by Venminder (or other software provider).

Venmonitor: Module provided by Venminder (or other software provider) that aggregates data from data intelligence providers (i.e., “data partners”) to generate a quick, high-level inherent risk profile of any vendor.

Data Partner: Third-party organization that aggregates vendor data within a given risk domain. Typically, the data partner does not interact with the vendor directly to gather data, electing for gathering information from outlets such as the news media.

Application Programmable Interface (API): A module, graphical user interface, or other software that allows two or more computer programs or applications to communicate with each other and/or pass data therebetween.

Service Level Agreement (SLA): A service level agreement defines the level of service a user can expect from a vendor, laying out the metrics by which service is measured, as well as remedies or penalties, should agreed-upon service levels not be achieved. It is a critical component of any technology vendor contract.

Deep links: Deep links are a type of link that send users directly to an application instead of a website or a store. They are used to send users straight to specific in-application locations, saving users the time and energy locating a particular page themselves—significantly improving the user experience. As used herein, deep linking from within the provided software or systems to a data partner is a link directly to information within a data partner's portal, to a location that stores and/or displays data (for example, risk data) specific to a vendor of interest. As used herein, deep linking from within the provided software or systems to a data partner portal requires approval by the data partner for the provided software or systems to access the data partner portal. The access may be pre-arranged between Venminder (provider of the software and systems described herein) and each data provider, thereby allowing any Venminder client to utilize Venminder's pre-arranged access to the data partner's portal to view vendor risk data, as described herein. As used herein, deep linking from within the provided software or systems to a data partner portal may also require a subscription, which also may be pre-arranged by Venminder, and which also may be leveraged by the client to view vendor risk data, as described herein.

### DETAILED DESCRIPTION

Methods and systems are presented herein for assessing risk associated with a vendor providing services and/or other products to a financial institution, for preparation of associated risk assessment reports or vendor oversight reports, and for maintenance of a plurality of risk assessment reports associated with a plurality of vendors. In some embodiments, the disclosed methods and systems may be used to access data from third party data partners (i.e., data providers, i.e., data aggregators) that provide risk assessments based on different aspects of risk. In some embodiments, the disclosed methods and systems may be used to aggregate risk data from different data partners to arrive at a single risk rating for a given vendor, the single risk rating incorporating all of the various aspects of risk from the multiple data providers.

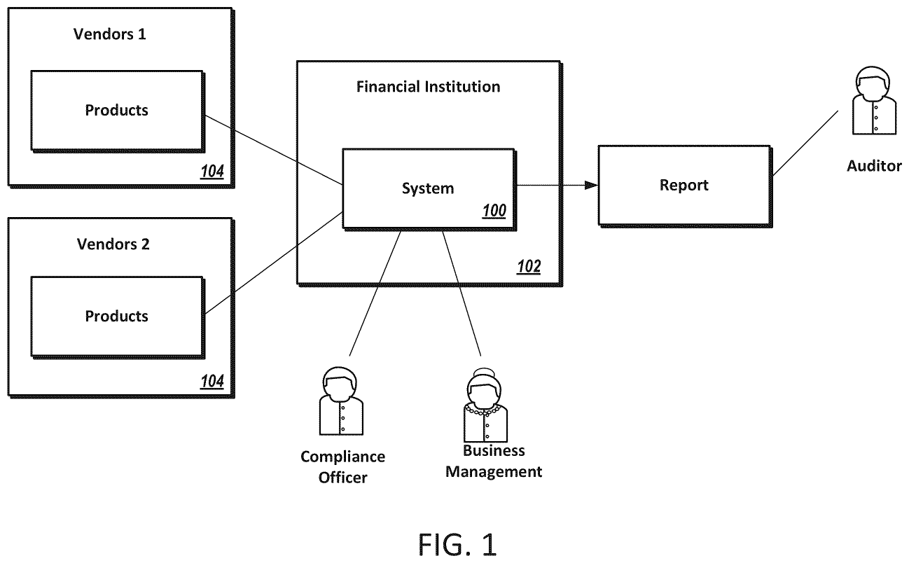

FIG. 1 is a block diagram of an example system 100 to assist financial institutions 102 to manage vendors 104 in accordance with an embodiment of the invention. In some implementations, the system 100 provides guided workflow to i) manage contracts with a given vendor 104, to provide a guided workflow to assist the financial institution 102 to prepare for an compliance or contract audit examination, ii) provide a rating system of the vendors 104 and their products and services, iii) provide a risk-assessment rating-system for the vendors 104, and iv) provide mechanisms for collaboration, the tracking of communication, and document storage.

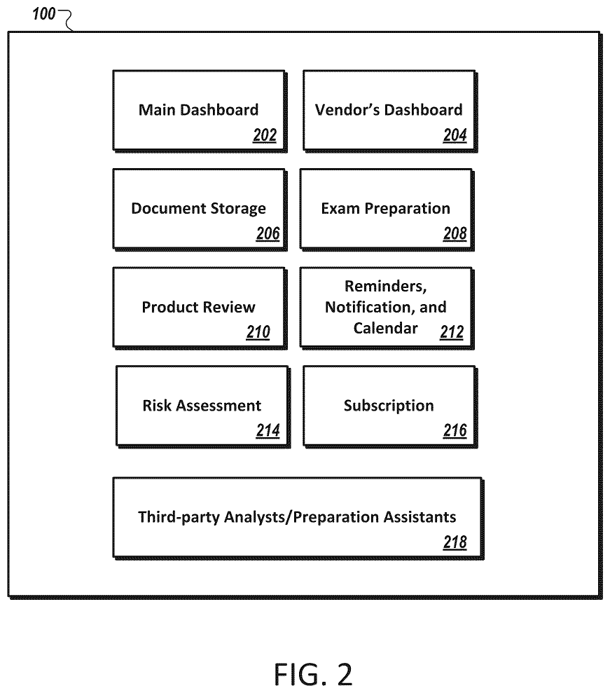

FIG. 2 is a block diagram of the example system 100 for managing contracts between the financial institution and its vendors in accordance with an embodiment of the invention. The system 100 may include a main dashboard 202 for managing actions associated with a given vendor 104 and to track such actions. The system 100 may include a vendor dashboard 204 to view and manage products and vendors associated with a given financial institution. The system 100 may include a document storage page 206 to view and manage documents associated with the vendors and their products. In some implementations, the document storage page 206 may be accessible via the main dashboard 202 and the vendor dashboard 204.

The system 100 may include a reminder, notification, and/or calendar function 212. The function 212 may manage and store a list of dates associated with expiration of a given document or contract as well as a list of personal reminders provided by the end-users. The function 212 may display such reminders in a calendar display. The function 212 may send notifications to the end-user based on pre-defined rules associated with an examination. The rules may be related to the expiration date of a given product or agreement, a scheduled examination, a risk-assessment evaluation, and etc.

The function 212 may include an alert and/or information feed (e.g., new documents uploaded, new reviews added, status update on a given examination or preparation process, etc.). The alert may include a progress bar to indicate a given end-user progress with a given task.

The alert may include an experience bar to indicate a given end-user usage level associated with the various functions of the system 100.

The system 100 may include a risk-assessment module 214 to guide an end-user in assigning a risk rating for a given vendor and/or product. The risk-rating may be utilized as part of the reporting of the compliance and/or contract audit examination. In some implementations, the risk rating may be used to determine the types of information and the types of documents to include in the examination report.

The system 100 may include a subscription module 216. The subscription module 216 may manage and maintain usage by the end-user of the various system components (e.g., 202, 204, 206, 208, 210, 212, and 214) for a given financial institution. The system 100 may monitor the end-user's action, such as the usage of complimentary tools and document storage, purchases of additional tools and document storage, purchases of enterprise features, among others.

In some example embodiments, the system may include one or more modules for executing, providing and/or causing to display one or more graphical user interfaces (GUIs) and/or widgets. The GUIs and/or widgets may include a vendor profile widgets for, among other things, managing vendor profiles; oversight grid widgets for, among other things, providing grid-based oversight of oversight requirements; task widgets for, among other things, managing tasks associated with oversight requirements; oversight management widgets for, among other things, managing tasks and oversight requirements associated with vendors and/or vendor products; document widgets for, among other things, managing documents associated with tasks; administrator widgets for, among other things, managing users; dashboard widgets for, among other things, managing outstanding tasks and vendor products associated with users; and reports widgets for, among other things, generating status, task and/or vendor reports.

In some example embodiments, data associated with vendors (e.g., vendor management information), which is used by the GUIs and/or widgets, may be stored in a memory of the system 100 or of a client computing device associated with the system 100. In some example embodiments, the system 100 is an enterprise system with which one or more enterprise client computing devices are connected. The GUIs and/or widgets are described in further detail below.

### Main Dashboard

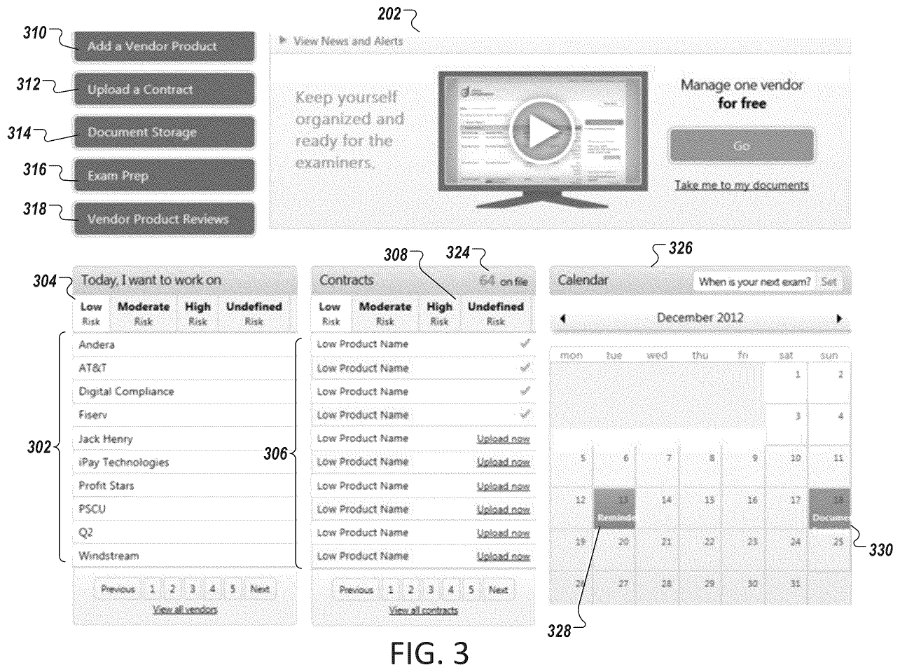

FIG. 3 is an example main dashboard 202 in accordance with an embodiment of the invention. The main dashboard 202 may be used to initiate the various functions, as described in relation to FIG. 2. The main dashboard 202 may display a vendor list 302, which may be organized and filtered by a vendor's risk level 304 (e.g., low, medium, high, or undefined/unknown). The main dashboard 202 may display a contract list 306, which may also be organized and filtered by risk levels 308. The main dashboard 202 may display a number of contracts on file (324), such as those stored in the document storage 206.

The main dashboard 202 may include a calendar 326 that displays reminder dates 328 and expiration dates 330 of contracts, of risk assessment of vendors and/or products, as well as of upcoming examinations. In some implementations, the calendar 326 may include dates in which notifications will be sent by the system. In some implementations, the calendar 326 may only display the expiration dates for documents that are uploaded by the end-user.

In some implementations, upon selecting a date in the calendar 326, the system 100 may prompt the end-user to create a reminder (e.g., for email communication, SMS-message, and other methods of notification accessible to and specified by the end-user). The system 100 may display a content of a reminder when the end-user hovers the cursor thereover.

The calendar may be a part of the reminders, notification, and calendar function 212. The alerts and reminders of the calendar 326 may be employed to notify the end-user of upcoming critical dates (e.g., renewal date). The notification may be generated based on the date of the given activity having met an alert condition (e.g., exceeding a date threshold in relation to the critical date).

The main dashboard 202 may include a function to add a vendor product (310), a function to upload a contract associated with a given product (312), a function to manage stored documents (314), a function to prepare for an examination (316), and a function to review and manage reviews for a given vendor products (318).

The main dashboard 202 may be displayed to the users upon login to the system 100.

In some implementations, when adding a new vendor product (310), the system 100 may present the end user with a list of products. The list may include all products associated to the financial institution, including those that are not currently being managed by any of the end-user of that institution as well as those that do not have a contract loaded. The list of products may be maintained within a database that is managed by the system 100.

When adding a new vendor product, the system 100 may present the end-user with a list of questions associated with the product. The questions may include a request for the vendor name, the product name, the product type, and a risk level. The risk level may be defined as low, medium, high, and undefined (as corresponding to the risk level 304). Alternatively, the risk level may be an input from the risk-assessment module 214.

In some implementations, the risk-levels 304, 308 may be used to determine a suggested document in the examination-preparation area. Once the vendor product is added, the system 100 may present the end-user with a notification that the product has been added. In the notification, the system 100 may include a link or a selection that allows the end-user to upload a contract associated with the added vendor product. The system may also provide a link or selection to add a collaborator or to add contact information of the vendor.

In some implementations, the system 100 allows more than one person to interact with a vendor. The collaboration function allows the system 100 to receive information from the end-user about co-workers or other people in the end-user's organization that may perform actions or provide reviews for a given vendor and/or vendor product. In some implementations, the collaborator may perform any of the end-user's function (e.g., upload contract, add notes and reminders, save email conversation, and document events), though may not change or undo any of the actions performed by the end-users. Each of the vendor products may be assigned a different point of contact (i.e., a product manager). The system 100 may provide a search function for the end-user to determine if an added collaborator is already registered with the system 100.

In some implementations, when uploading a contract associated with a given product (312), the system 100 may prompt the end-user for a file. Multiple files may be selected and uploaded in a given instance. The system 100 may send a notification to the end-user that the contract has been uploaded and that a notification will be sent when it is ready for review. In some implementations, the contract may be transmitted to a third-party that analyzes and/or prepare the contract for review by the end-user. The system 100 may use aliases table. Examples of tools utilized by the third-party to analyze and prepare the contract are described in Appendices E and F of the U.S. Provisional Patent Application No. 61/805,066, which is incorporated by reference herein in its entirety.

### Vendor Dashboard

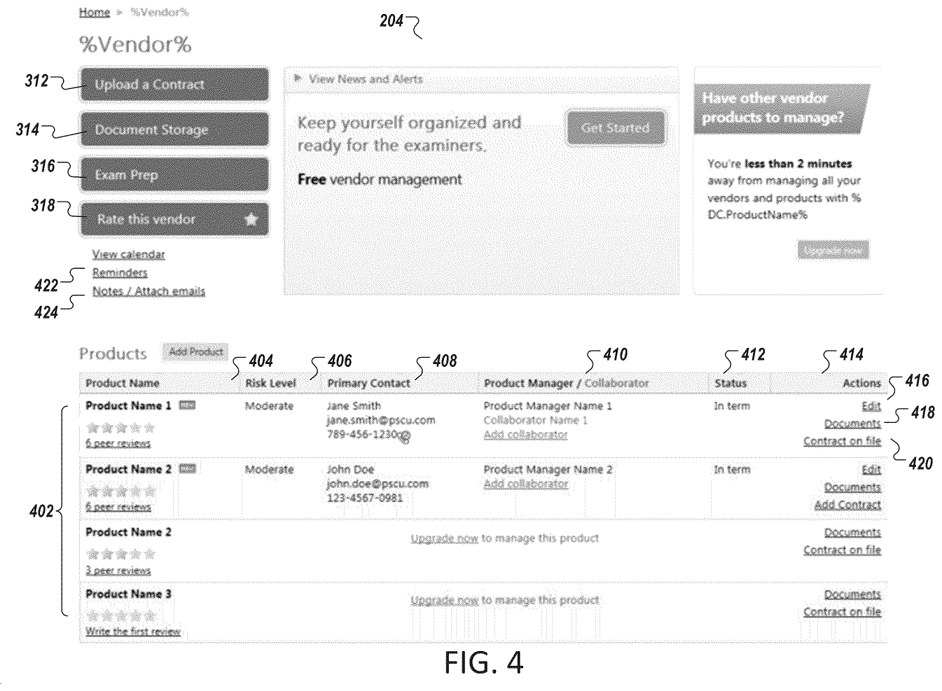

FIG. 4 is an example vendor dashboard 204 in accordance with an embodiment of the invention. In some implementations, the vendor dashboard 204 may be accessed by the end-user when the user selects a vendor from the list of vendors 302 in the main dashboard 202.

In some implementations, the vendor dashboard 204 may include the function to upload a contract associated with a given product (312), the function to manage stored documents (314), the function to prepare for an examination (316), and the function to view and manage reviews for a given vendor products (318).

In some implementations, the vendor dashboard 204 may include a list of vendor products (402) that are associated to the financial institution. The list 402 may include, for example, but not limited to, products that are currently being managed as well as products that are yet to be assigned to a given product manager. For each of the products in the list 402, the system 100 may display a product name 404, a risk level that has been assigned to the product 406, a vendor contact information 408, an assigned product manager (of the financial institution) 410, a status indicator of the product 412, and actionable tasks 414 associated with a given product. The actionable tasks 414 may allow an end-user to edit a given product information (416), to view or manage the document associated with the given product (418), and to add a contract or edit the contract on file associated with the given product (420).

Upon a selection of a product in the list 402, the system 100 may prompt the end-user whether to assign a product-manager for the product. The prompt may further include details and information about the product, including, for example, the vendor name, the product name, the product type, and the source of the product. Upon the end user providing the information, the system 100 may provide options to allow the end-user to upload a contract, to add a collaborator, or to add contact information.

Upon a selection to edit a product (416), the system 100 may display the information about an added product (e.g., the vendor name, the product name, the product type, and a risk level), as described in FIG. 3. The system 100 may also display the vendor's contact-information and/or a list of assigned collaborators.

The system 100 may provide a selection to allow the end-user to remove collaborators from specific products.

Upon a selection to edit a contract (420) associated with a product, the system 100 may display information relating to the contract, including the status of the contract (e.g., “in-term”, “renewal negotiation”, “auto-renew”, “cancelled”, “replaced”, etc.), the contract files (which may include one or more files), the end-user that uploaded the contract, the upload date, the contract date, the contract expiration date, a list of products associated with the contract, and certain key clauses (e.g., whether the contract includes an auto-renewal clause, information relating to the number of days required for a non-renewal notice, and an auto-renewal period). The system 100 may also display information relating to the contract terms (e.g., sale price per unit, etc.), comments associated with the term (e.g., whether the contract is a service-level agreement (SLA)), the vendor signatory, the institution signatory, among others. The system 100 may provide a prompt to the end-user to edit or replace the contract.

In addition, the system 100 may take actions and set reminders. Example actions of the system 100 are summarized in Table 1.

TABLE 1
Examples of Actions and Reminders

| Status | Description | Action | Email Communication |
|---|---|---|---|
| In Term | Contract has | No action taken | Initiate communication |
| | not reached | | six months from |
| | expiration date | | expiration date |
| Renewal | Financial Institution | No action taken | Sent on the |
| negotiation | is working on a | | expiration date |
| | new contract terms | | |
| Auto- | Automatically renew terms | Change the contract | Sent on the |
| Renew | of the contract based | expiration date based | expiration date |
| | on the info entered | on the terms loaded | |
| | when the contract | in the upload | |
| | was loaded | contract form | |
| Cancelled | Contract is no | All products/ | Sent on the |
| | longer valid | documents associated | expiration date |
| | | with the contract will | |
| | | also be in cancelled | |
| | | status and archived | |
| Replace | Financial Institution | Move old contract to | |
| | replacing the existing | archives/new | |
| | contract with a new one | contract starts the | |
| | | upload contract | |
| | | process over | |

In addition, upon a selection to edit a contract, the system 100 may provide guidance to the end-user depending on the various selected options. For example, if the end-user specifies “renewal negotiation” (which indicates that the end-user is currently negotiating the contract with the vendor), the system 100 may provide a message that states: “By setting a contract to renewal-negotiation, you will no longer receive notices regarding contract expiration and/or auto-renewal. Change your status when you are ready. You can either upload your new contract or cancel your existing contract.” The system 100 may also take action, such as to stop the sending of the contract expiration emails.

In another example, if the end-user specifies “auto-renew” (which indicates that the contract would auto-renew with the terms as originally provided), the system 100 may prompt the end-user for a new expiration date for the contract and a date for new reminders.

In yet another example, if the end-user specifies “cancelled” (which indicates that the contract has been canceled), the system 100 may notify the end-user that the system 100 will cancel all of the selected products, archive all of the uploaded documents, and archive all of the uploaded contracts. The system 100 may also prompt the end-user for new vendor information. The system 100 may also prompt the end-user to upload a new contract or document.

In yet another example, if the end-user specifies “replace contract” (which indicates that the end-user wishes to replace an existing contract with a new contract), the system 100 may prompt the end-user for new documents associated with the new contact. The system 100 may archive the old contract in an archived folder. The old contract may be accessible to the end-user at the document storage page 206. In some implementations, the system 100 may also sent the new document to the third-party 218 for analysis and preparation.

Still looking at FIG. 4, the vendor dashboard 204 may include features to assist the end-user in managing reminders and notes associated with the vendor product. For example, the vendor dashboard 204 may include an option to display all of the reminders (422) associated with a given vendor.

The vendor dashboard 204 may include an option to attach and view notes and correspondences (424) (e.g. electronic mail) associated with the vendor. In some implementations, the system 100 may present the information as a list that includes the dates that the note was created, a title for the note, a note type, a product name, an identifier of the end-user that created the note, a vendor name, a product name, and a note message. The list may be filed, sorted, or organized using the note title, the email information, or by the product information.

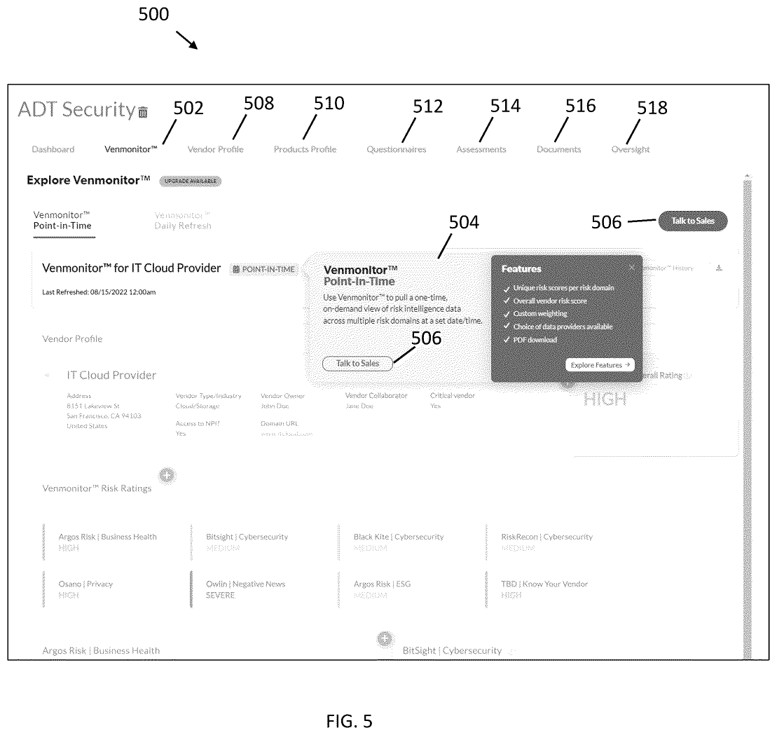

FIG. 5 illustrates another example vendor dashboard 500, in accordance with an embodiment of the invention. In the embodiment of FIG. 5 (as is also possible for the vendor dashboard of FIG. 4), the Venmonitor is accessible via the Venmonitor tab 502, in addition to other tabs such as the overall vendor dashboard, the vendor profile tab 508, products profile 510. Questionnaire 512, assessments 514, documents 516, and/or oversights 518. The Venmonitor module 502, provided by Venminder, aggregates data from data intelligence providers (i.e., “data partners”) to generate a quick, high-level inherent risk profile of any vendor. When a client does not have Venmonitor 502 in their purchase plan, the user will be presented with educational content 504 to learn more about this offering. The page may navigate the user through a series of prompts that highlight key features of Venmonitor 502. The educational content 504 includes an option 506 to reach out to a Venminder sales representative for upgrade.

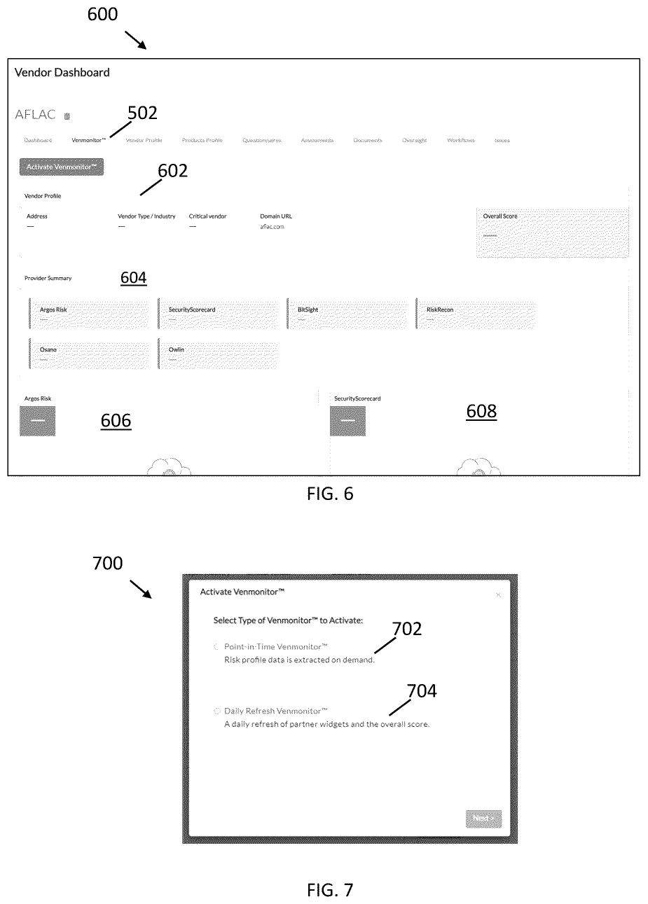

FIG. 6 is an example vendor dashboard activation page 600, in accordance with an embodiment of the invention. If Venmonitor 502 has been purchased but has not been activated for a vendor, the tab will display placeholder widgets (for example, vendor profile 602, provider summary 604, Argos risk 606, Security Scorecard 608, etc.) representative of each data partner listed in the purchase plan.

FIG. 7 is an example activation dialog box 700, in accordance with an embodiment of the invention. The Venmonitor activation dialog box 700 aids in the activation process. To begin the Venmonitor activation process, the user must first select the desired option. The Venmonitor 502 options may include Point-in-Time 702 and Daily Refresh 704. Selecting the One-Time option (i.e., Point-in-Time 702) will provide a secondary option on whether an executive summary should be performed.

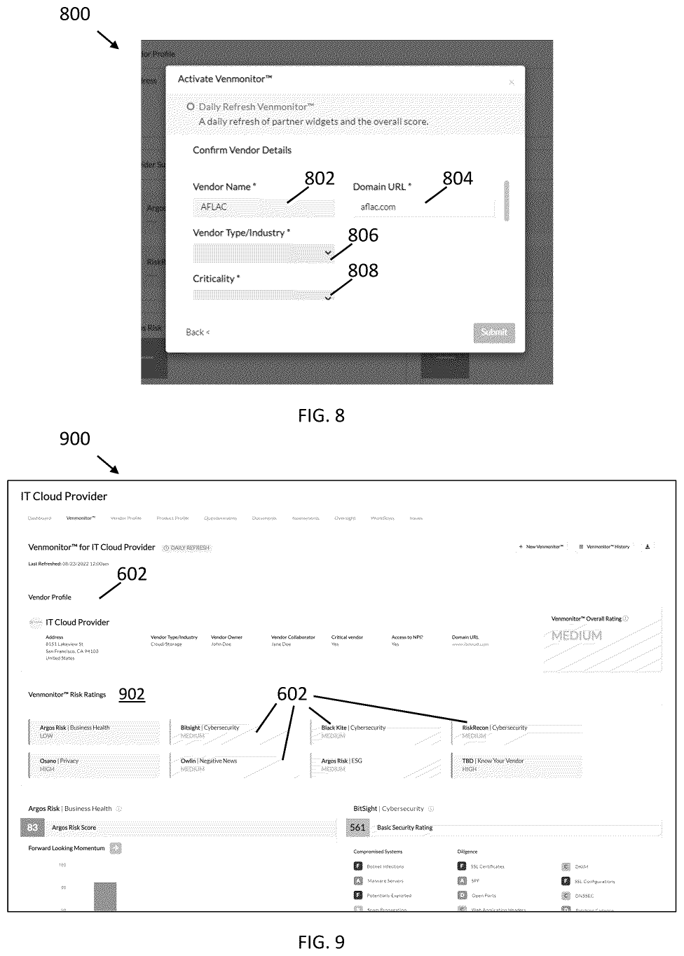

FIG. 8 is an example activation dialog box 800, in accordance with an embodiment of the invention. Once a Venmonitor 502 option has been selected, the user will be requested to input and confirm vendor details in a vendor name field 802. Key pieces of information such as domain URL 804 and address are needed to ensure that the correct vendor is provisioned to each data partner portfolio. To help expedite this process, the system will automatically prefill any data already stored by the client within the vendor profile 508 (shown in FIG. 5). The activation dialog box 800 may also include a vendor type (or Industry) field 806 for entering the industry in which the vendor operates, as well as a criticality field 808, for indicating how critical the vendor is to the user/client's ongoing operations. In some embodiments, a criticality assessment section of a form may use the same questions as those on a standard “add a vendor” form. In some embodiments, the system may set the vendor to “critical” if ‘Yes’ is selected in response to any one of questions on a vendor request form (e.g., via an appropriate vendor request form GUI). If the criticality field has already been answered in the vendor profile 508, the system 100 will automatically import that information into the Venmonitor activation dialog box 800.

FIG. 9 is an example Venmonitor download page 900, in accordance with an embodiment of the invention. When a vendor has been provisioned for all data partners, the system will deliver Venmonitor 502 to the client. At this time a notification may be sent to prompt the client to access the site to review the data. The review may include a review of the vendor profile 602, as well as ensuring that the Venmonitor risk rating widget 904 includes each of (and only) the selected or activated data partners 902. If the client selected the Daily Refresh option 704 (shown in FIG. 7), the system would pull data from each data partner via the API every 24 hours. Users will have the option to download a PDF version of Venmonitor. Users will also be able to download any One-Time or One-Time Executive Summary previously ordered, and may also download the current Daily Refresh data set.

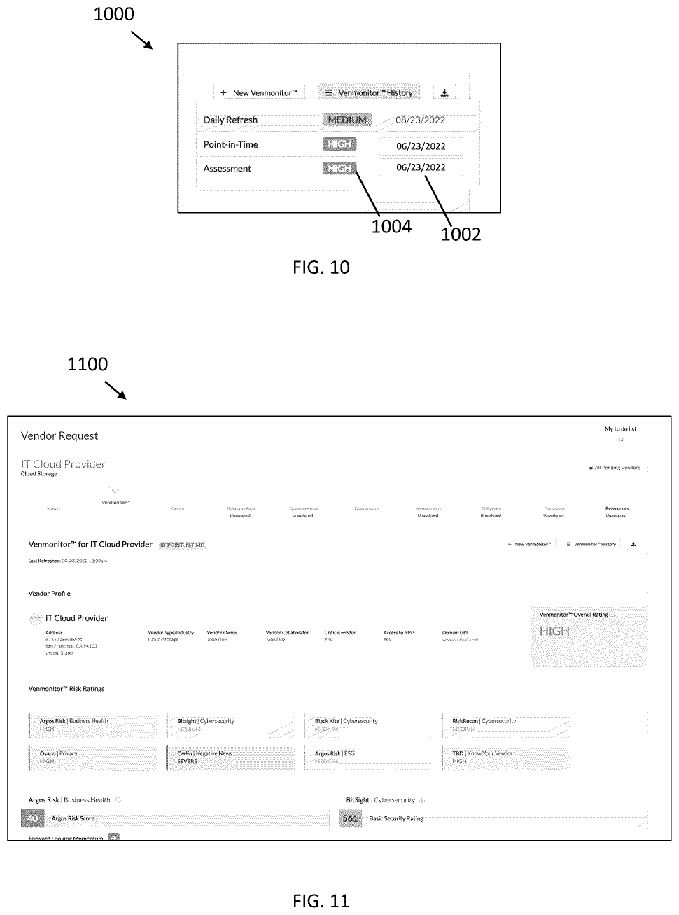

FIG. 10 is an example Venmonitor history window 1000, in accordance with an embodiment of the invention. Using the history window 1000, users will be able access a history of Venmonitor activated/ordered for the vendor. The history window 1000 may include a presentation of all One-Time and One-Time Executive Summary ordered on the vendor, with the order date 1002 and overall rating 1004. Clicking on the historical item would update the tab view to reflect data from that item. If the vendor is currently on Daily Refresh, the history would only show one line item with the date of the latest data pull and normalized overall rating. The history window 1000 may be used to determine if a vendor overall risk appears to be changing as a function of time (for example, to gauge whether the overall risk profile of a vendor is getting inherently more risky or less risky, over time).

### New Vendor Request in Onboarding

FIG. 11 is an example Venmonitor onboarding request 1100, in accordance with an embodiment of the invention. Using the Venmonitor onboarding request 1100, One-Time and One-Time Executive Summary reports are available for order for new vendor requests in the Vendor Onboarding module. While the client may not be in a contractual engagement with the vendor, Venmonitor 502 may be leveraged to gain unbiased risk insights within a short amount of time. Venmonitor 502 helps inform the client on next steps and whether they should proceed to approve the vendor request. According to aspects of the present embodiments, a tab for Venmonitor 502 may be displayed on the vendor request. Activation flows remain the same as Venmonitor orders via the vendor dashboard 500, as described in the previous section. Stated otherwise, Venmonitor 502 may be activated via either the vendor dashboard 500, or via the vendor request. Upon vendor approval, any Venmonitor 502 ordered will carry over into the vendor dashboard 500 for future reference.

### Data Partners

Venminder has brought together various leading data partners across various risk domains to provide insight into the risk profile of a vendor/supplier in an aggregate Venmonitor. As shown in the Table 2 below, the data partners have expertise in domain areas such as business health; credit risk; environmental, social, and governance (ESG); privacy, cybersecurity, negative news, know your vendor (including sanctions, politically exposed person (PEP) screening, negative news, and/or criminal activity); and/or dark web risks. Each of the data partners have expertise in a subset of these risk areas, allowing each to focus on only those domains in which they specialize, thereby providing the most accurate risk assessments within each area.

TABLE 2
Examples of Data Partners and Expertise Domains

| Data Partner | Domain |
|---|---|
| Argos Risk | Business Health, Credit Risk and |
| | Environmental, Social, & Governance |
| Osano | Privacy |
| RiskRecon | Cybersecurity |
| BitSight | Cybersecurity |
| Black Kite | Cybersecurity |
| Owlin | Negative News; Environmental, |
| | Social, and Governance |
| SecurityScorecard | Cybersecurity |
| Moody's | Environmental, Social, |
| | and Governance (ESG) |
| Quantifind/Sayari | Know Your Vendor - |
| | (Sanctions & PEP Screening, |
| | Negative News, Criminal Activity) |
| To be selected | Dark Web |

### API Integrations

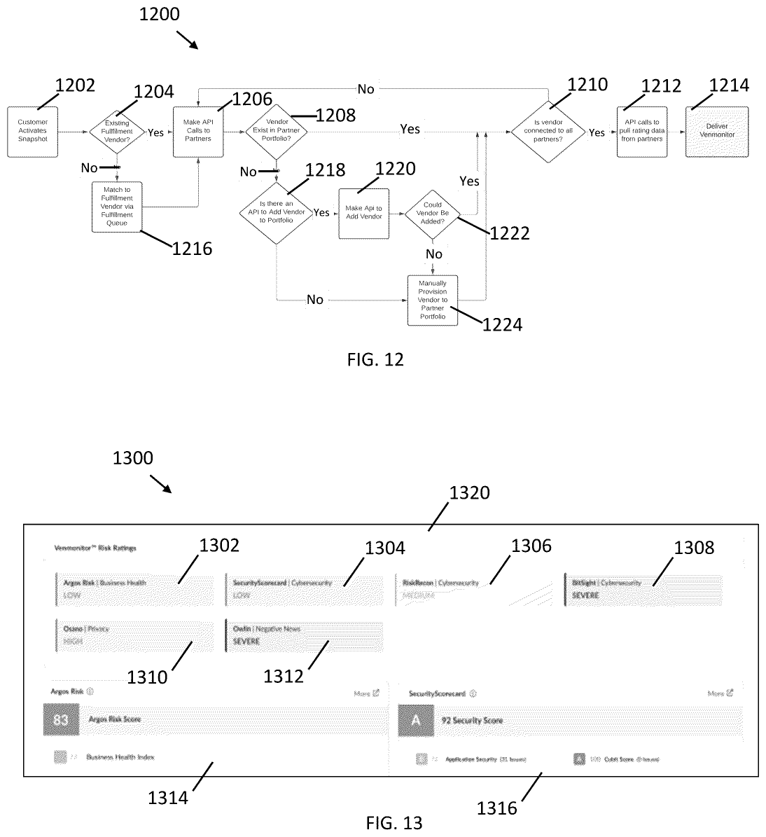

According to aspects of the present embodiments, a Venminder portfolio account may be created with each data partner so that Venminder can add requested Vendors to the account in order to pull data on those vendors to populate Venmonitor. Provisioning the vendor to the portfolios may occur programmatically via API or manually by a Venminder team member. The Venminder system performs the following API calls to each data partner: 1) verify if the vendor exists in the data partner's database, and 2) pull the vendor data into Venmonitor, as described in further detail with regard to FIG. 12.

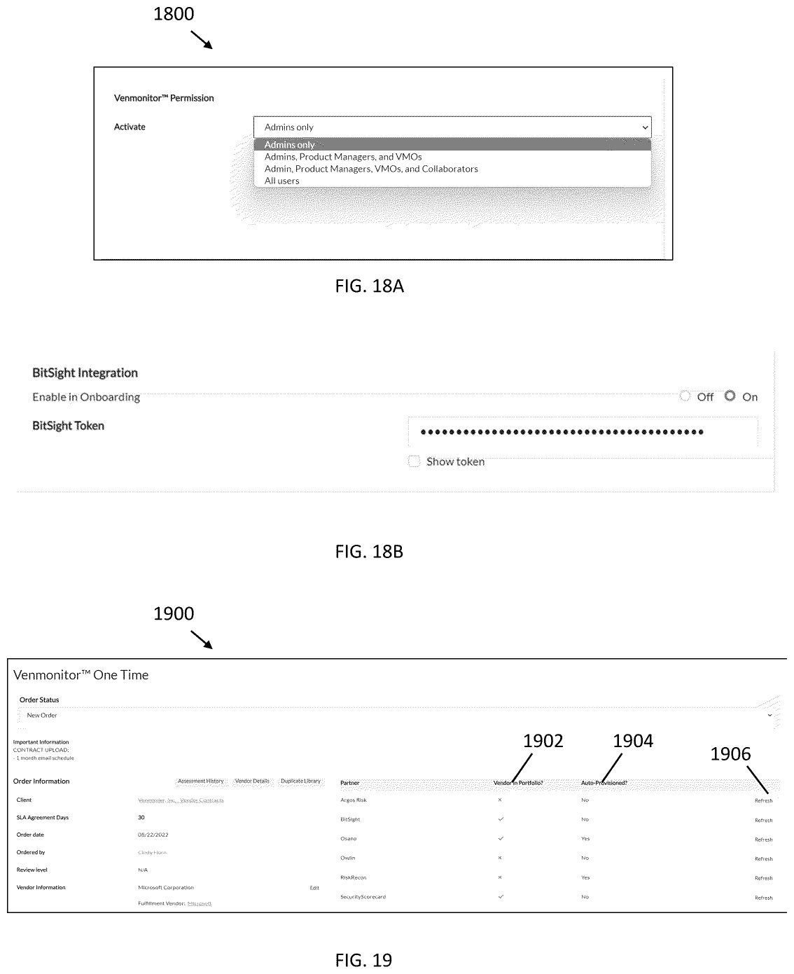

FIG. 12 is an example process flow 1200 illustrating API integrations, in accordance with an embodiment of the invention. For example, FIG. 12 illustrates the interaction between Venminder (i.e., the Venmonitor module 502) and a data partner with respect to a given vendor (for example, a vendor of interest). At step 1202, the process 1200 may include the customer or client activating the snap-shot (as described herein, in connection with FIGS. 5-9). At step 1204, the process 1200 may include checking if the vendor of interest is an existing fulfillment vendor. If the vendor of interest is an existing fulfillment vendor, at step 1206, the process 1200 may include making one or more calls to data partners of interest to understand if the vendor of interest exists in the data partner's library or portfolio. For example, in some embodiments, the process 1200 may include submitting an API token to the data partner to authorize access to the data partner's portal. If the vendor of interest is not an existing fulfillment vendor, at step 1216, the process 1200 may include matching and providing the data required for fulfillment vendors via the fulfillment queue (described in further detail in connection with FIG. 19), and then proceeding to step 1206, as described above. At step 1208, the process 1200 may include assessing if the vendor exists in the data partner's portfolio. If the vendor exists in the data partner's portfolio, at step 1210, the process 1200 may include assessing if the vendor of interest is connected to all data partners of interest. If the vendor does not exist in the data partner's portfolio (i.e., which is determined at step 1208), at step 1218, the process 1200 may include assessing if there is an API to add the vendor to the portfolio. If there is an API to add the vendor, at step 1220, the process 1200 may include making an API to add the vendor. At step 1222, the process may include determining if the vendor was able to be successfully added to the data partner's portfolio of vendors. If the vendor was unable to be successfully added to the data partner's portfolio of vendors, or if there was no API to add the vendor (determined at step 1218), at step 1224, the process 1200 may include manually provisioning the vendor of interest to the portfolio(s) of the data partner(s) of interest. For example, the process 1200 may send an indication or notification to the one or more internal users (i.e., Venminder administrators) indicating that the vendor needs to be manually provisioned for the data partner in question. Once the vendor has been added (i.e., provisioned) to the data partners' portfolios either manually or via an existing API, the process 1200 may proceed to step 1210 (assessing if the vendor of interest is connected to all data partners of interest). In some embodiments, a fulfillment vendor may be auto-authenticated by Venmonitor as existing in the data partner's library by use of guaranteed unique evidence, in connection with the API. For example, the Venmonitor API may include one or more fields that contain guaranteed unique evidence (such as a web domain or TIN (i.e., taxpayer identification number)) for a given vendor that is guaranteed not to be duplicated (that is, two different fulfillment vendors cannot have the same web domain or TIN). If the one or more guaranteed unique evidence fields of the Venmonitor API matches the corresponding field(s) for the vendor in question in the data partner API, the identification of the fulfillment vendor becomes auto-authenticated.

Referring still to FIG. 12, if the vendor of interest is not connected to all data partners of interest, the process 1200 returns to step 1206 where API calls are made to data partners (and the other steps described above (for example steps 1208, 1218, 1220, 1222, 1224, and 1210) are repeated until the vendor of interest is connected to all of the data partners of interest. Once the vendor of interest is connected to all of the data partners of interest, at step 1212, the process may include making API calls to pull rating data from the data partners of interest. At step 1214, the process 1214 may include delivering Venmonitor (via the Venmonitor module 502) to the client for the vendor of interest (i.e., Venmonitor including the associated risk ratings for each of the relevant vendor/data partner combinations). The process 1200 described herein, and illustrated in FIG. 12, may then be repeated for each additional vendor of interest.

### Venmonitor Scoring

The present embodiments present a method of deriving an overall risk score on a vendor/supplier based on the risk scores from the specific data and/or data points returned from each data provider. Given each data provider has different data points and individual risk scoring methodologies, the present embodiments include a normalized risk score on each data provider that rolls up into Venminder's overall risk score (i.e., the overall risk score provided by the present embodiments). The present embodiments provide a partner risk summary that normalizes the risk score of each data partner using the following risk categorization. The risk scores displayed at widget level remains at the data provider's scoring method. For each data provider, regardless of the risk/rating scales that are actually used (for example, 300-850 for credit scores) the risks are normalized as follows:
Low Risk: rating of 1 based on individual data provider normalization.
Medium Risk: rating of 2 based on individual data provider normalization.
High Risk: rating of 3 based on individual data provider normalization.
Severe Risk: rating of 4 based on individual data provider normalization.

As it applies to credit scores, for example, credit scores in a range from 300-629 may be associated with poor credit, and may be assigned a severe risk rating, which normalized to a risk rating of about 4 and above. Credit scores in a range 630-689 may be associated with fair credit, and may be assigned a high risk rating, which may be normalized to a risk rating of about 3.5, or from about 3.0 to 3.99. Credit scores in a range 690-729 may be associated with good credit, and may be assigned a medium risk rating, which may be normalized to a risk rating of about 2.5, or from about 2.0 to about 2.99. Credit scores in a range of 729 and above may be associated with excellent credit, and may be assigned a low risk rating, which may be normalized to a risk rating of about 1.5, or from about 1.0 to about 1.99. Therefore, the normalized risk ratings of the present embodiments are associated with higher risk, the higher the numerical value.

In another example, data partner Osano provides a privacy rating that ranges from 300-830 (i.e., close to that of the credit rating scale), but is very different than the credit rating scale in terms of how risk is assessed and categorized. For example, using the Osano privacy rating, scores from 713-850 correspond to severe risk, scores from 575-712 correspond to high risk, scores from 438-574 correspond to medium risk, and scores from 300-437 correspond to low risk. Therefore, in addition to the Osano privacy rating including different numerical values (i.e., upper and lower limits) for the different risk categories (i.e., when compared to the credit rating scale), the Osano privacy rating runs in the opposite direction as the credit rating scale from a risk point of view. With the Osano privacy rating, high values are associated with higher risk. With the credit rating scale, higher values are associated with lower risk. Therefore, averaging the values would not be an effective way of assessing overall risk from these two very different risk scales. The risk normalization methodologies provided herein, by contrast, provide an effective way of assessing overall risk of vendors, taking multiple aspects of risk into account, and providing for different rating scales.

In another example, data partner BitSight provides risk scores in terms of letter grades from A to F, with A representing low risk and F representing high risk. In another example, data partner RiskRecon provides both a letter grade from A to F as well as a numerical grade from 0 to 10, with A and 10 representing low risk, and F and 0 (zero) representing high risk. As described herein, each of these individual risk ratings may be normalized to a single risk rating scale (for example, a numerical scale from 1 to 4) where 1 represents low risk and 4 represents high or severe risk.

FIG. 13 is an example Venmonitor partner summary 1300, in accordance with an embodiment of the invention. The partner summary 1300 includes a Venmonitor risk ratings widget 1320 several individual data partner risk ratings including a low risk Argos rating for business health, a low risk SecurityScorecard rating for cybersecurity, a medium risk RiskRecon rating for cybersecurity, a sever risk BitSight rating for cybersecurity, a high risk Osano rating for privacy, and a severe risk Owlin rating for negative news. As such, in the embodiment illustrated in FIG. 13, the risk ratings widget 1320 includes risk ratings from 6 different data partners (Argos, SecurityScorecard, RiskRecon, BitSight, Osano, and Owlin) in 4 different categories (business health, cybersecurity, privacy, and negative news). Notably, in the embodiment illustrated in FIG. 13, the risk rating widget 1320 (and the Venmonitor module in general) may include certain categories (cybersecurity in this case) with risk scores from multiple data partners. FIG. 13 also illustrates additional details of the Argos risk score 1314 (which in this case is an 83) for business health, as well as the SecurityScorecard risk score 1316 for cybersecurity (which in this case is an A). Both the Argos risk score 1314 (for example, which may be on a scoring scale of 0-100) and the SecurityScorecard risk score 1316 (for example, which may be on a scoring or grading scale of A through F) have been normalized by the Venmonitor module 502 such that they are on a 1-4 rating scale, as described herein. By normalizing the risks of all of the data partners, regardless of the individual scoring or grading scales they may use, users of the present embodiments may assess risk across risk categories to arrive at a single risk rating for each vendor.

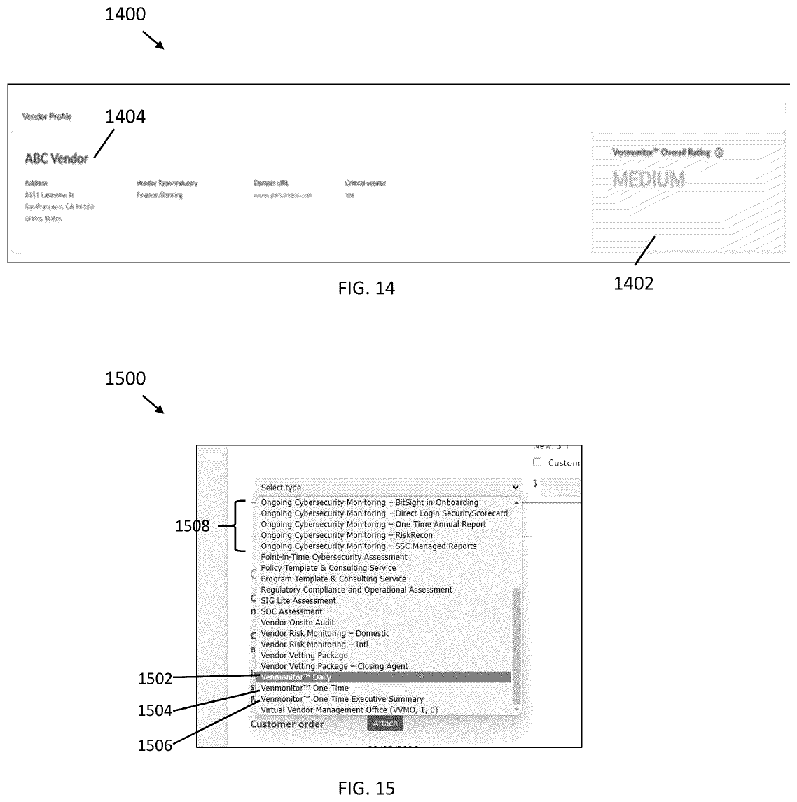

FIG. 14 is an example of an overall vendor rating 1400, in accordance with an embodiment of the invention. The overall vendor rating 1400 includes a single risk rating for each vendor that incorporates all of the individual risk ratings from the data partners. Once normalized, as described above, an average of the individual risk ratings from the data partners to arrive at the single risk rating. In some embodiments, a median score of the individual risk ratings from the data partners may be used instead of an average. In some embodiments, other methods of aggregating the individual risk ratings from the data partners may be used. The aggregated numerical value that incorporates the normalized individual risk ratings from the data partners may then be converted into a single risk category. For example, in the embodiment of FIG. 14, the vendor in question 14040 (ABC Vendor) is associated with a medium level of overall risk.

In another example, based on the data providers available within an exemplary risk snapshot, the overall risk score (or vendor rating) 1400 is an average of the normalized risk scores for each widget or data partner. In this example, if there are four data provider widgets present within a risk snapshot, and the four normalized risk scores across the widgets are: Severe (5), High (4), Low (1), and Medium (3), the overall Venminder risk score would be 3.25, which correspond to overall risk score of High Risk for that particular vendor or supplier.

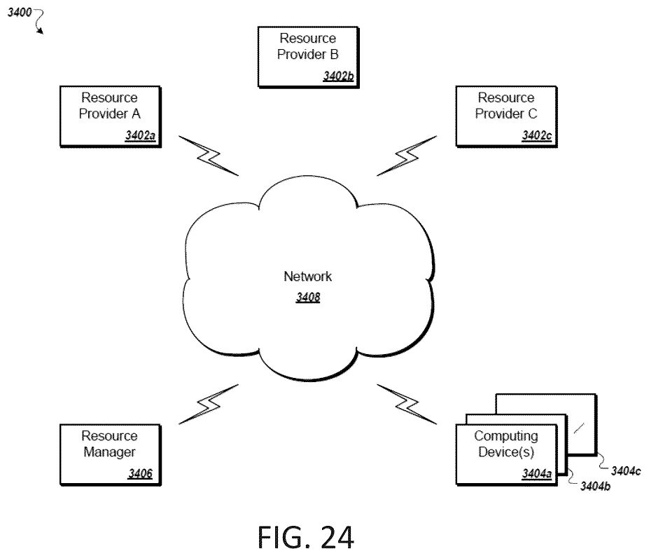

FIG. 15 is an example of a drop-down window 1500 presenting user options, in accordance with an embodiment of the invention. The Venmonitor module 502 (for example, the vendor risk assessment module) may be added as a service line item in a client's purchase plan. The system provides three options: Daily 1502, One-Time 1504, and One-Time Executive Summary 1506, which are illustrated and discussed in more detail in connection with FIGS. 23 and 24. Each offering may be managed at different price points as defined by Venminder or as negotiated with the client. As illustrated in FIG. 15, the drop down window 1500 also includes the ability to select ongoing monitoring 1508 on a per data partner basis (i.e., for users that are interested in reports from only a single data partner, or alternatively, a select few data partners).

FIG. 16 is an example of a drop-down window 1600 presenting user options, in accordance with an embodiment of the invention. Each Venmonitor option may be configured to only pull data from specific data partners. This provides flexibility to adjust the package to best suit the client's needs. For example, a client may only want to surface cybersecurity data in their Venmonitor deliverables. Accordingly, in connection with the present embodiments, users can select both the data partners they'd like to sign up for, as well as the associated service level (i.e., Daily 1502, One-Time 1504, and One-Time Executive Summary 1506) for each data partner.

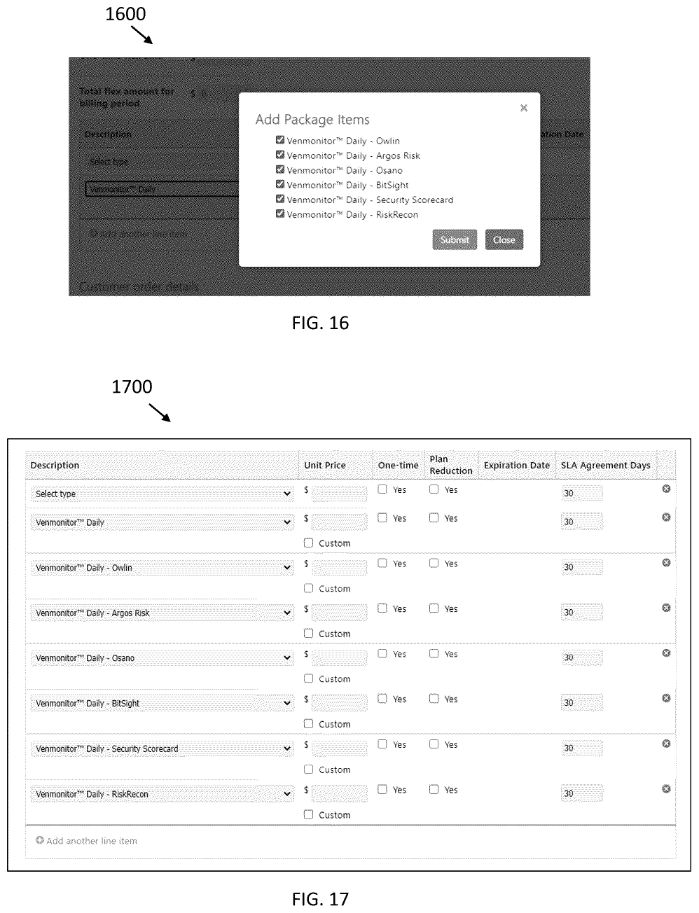

FIG. 17 is an example of a drop-down window 1700 presenting user options, in accordance with an embodiment of the invention. When the selection is complete, the system will display the overall option line, plus a line for each data partner. This permits the user to be provided with pricing at the per data partner level, if desired. By default, the system 100 provides a Core Bundle (shown in Table 3) at a pre-defined list price per vendor for each Venmonitor option available (daily, one-time, one-time with executive summary). In some embodiments, the system allows the ability to also include other data partners (i.e., for an additional fee).

TABLE 3
Examples of Data Partners in Core Bundle

| Data Partner | Domain | Package |
|---|---|---|
| Argos Risk | Business Health and Credit Risk | Core Bundle |
| | Environmental, Social, and Governance | |
| Osano | Privacy | Core Bundle |
| RiskRecon | Cybersecurity | Core Bundle |
| BitSight | Cybersecurity | Core Bundle |
| Black Kite | Cybersecurity | Core Bundle |
| Owlin | Negative News | Core Bundle |
| SecurityScorecard | Cybersecurity | Add-On |

### Venmonitor Permissions

FIG. 18A is an example of a drop-down window 1800 presenting user options, in accordance with an embodiment of the invention. In the Admin Panel System Settings 1800 shown in FIG. 18A, users (i.e., administrators) have the ability to manage who should have permission to activate Venmonitor to a vendor. Using this permission setting helps ensure that the functionality is only displayed to the proper users.

FIG. 19 is an example of a fulfillment queue 1900, in accordance with an embodiment of the invention. The fulfillment queue 1900 provides a screen summarizing the details of a user's order. New Venmonitor activations/orders are funneled through Venminder's fulfillment queue 1900 so that an internal team may monitor for any vendors that require manual entry into the data partner portfolio. The interface 1900 displays all data partners required for the Venmonitor order with the following information and functionality: vendor in portfolio 1902, auto-provisioned 1904, and refresh 1906. The vendor in portfolio 1902 functionality includes a green checkmark within each data partner row indicating that provisioning from that data partner to the account is complete. Incomplete provisioning is indicated with a red “x” indicator. The auto-provisioned 1904 functionality indicates “yes” or “no” on whether the API integration will automatically provision once the vendor is added to the partner service. If the API integration will not automatically provision, the vendor must be manually added to the partner service for provisioning to be complete. Finally, the refresh 1906 functionality is available for vendors with “x” under Vendor in Portfolio. Clicking the refresh 1906 causes the system to manually complete the provisioning via API.

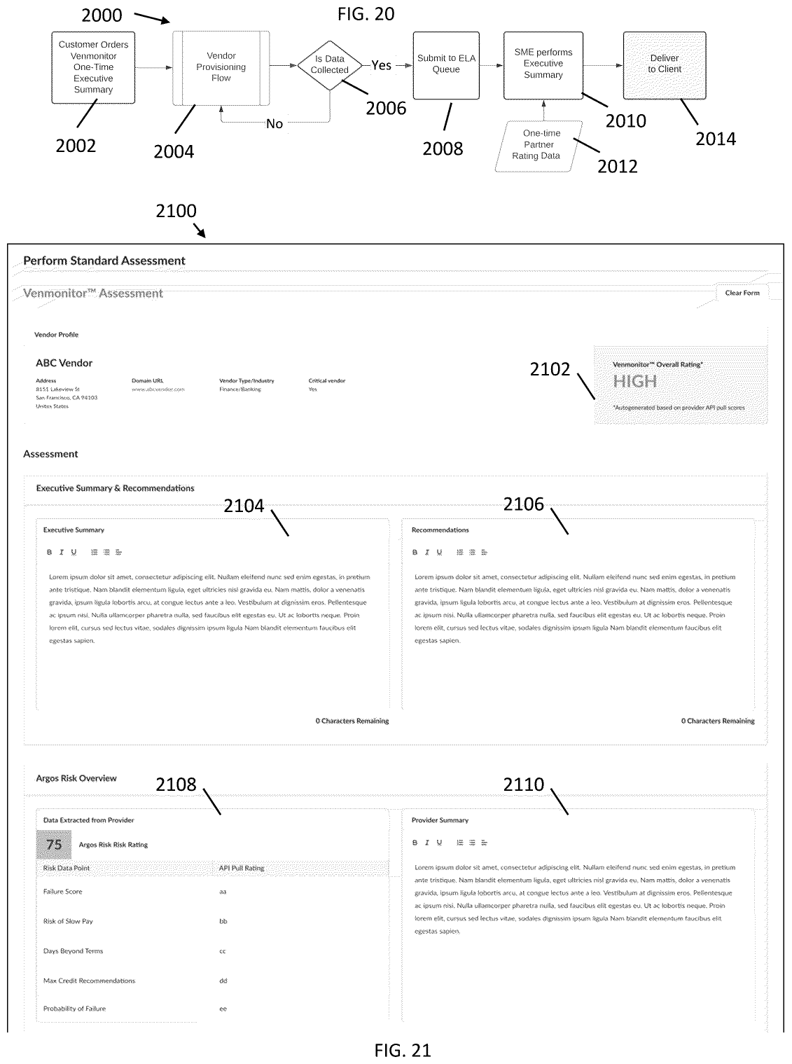

FIG. 20 is an example order flow process 2000 for the One-Time Executive Summary option, in accordance with an embodiment of the invention. For Venmonitor One-Time Executive Summary orders, the workflow may be are channeled through Venminder's Executive Level Analysis Queue where Venminder's subject matter experts (SME) may perform their assessment. According to aspects of the present embodiments, at step 2002, the process 2000 may include the customer or client ordering a Venmonitor One-Time Executive Summary. At step 2004, the process 2000 may include entering the vendor provisioning flow (for example, as described in connection with FIG. 12). At step 2006, the process 2000 may include assessing if data has been collected from the data partner. If data has not been collected, the process 2000 may include returning to step 2004. If data has been received from the data partner, at step 2008, the process 2000 may include assessing submitting the request to an Executive Level Analysis (ELA) Queue. At step 2010, the process 2000 may include the subject matter expert (SME) performing (i.e., compiling) the executive summary based on data from the data partner and the SME's expertise. In addition, at step 2012, the process 2000 may include using the one-time partner rating data in compiling the executive summary. At step 2014, once the executive summary is complete, the process 2000 may include delivery the executive summary to the client via the Venmonitor module 502.

FIG. 21 is an example Executive Summary Template 2100, in accordance with an embodiment of the invention. The Subject Matter Expert (SME) will access an Executive Summary template 2100 which includes the point-in-time data pulled from each data partner for analysis. According to aspects of the present embodiments, the Executive Summary template 2100 may include an overall vendor rating 2102, an overall executive summary 2104, and overall recommendations 2016, as well as individual data partner ratings 2108. Adjacent to each partner rating 2108, the SME may include additional feedback 2110 specific to each data partner. At the top of the template, fields to capture overall summary 2104 and recommendations 2016 are available for inputs from the SME.

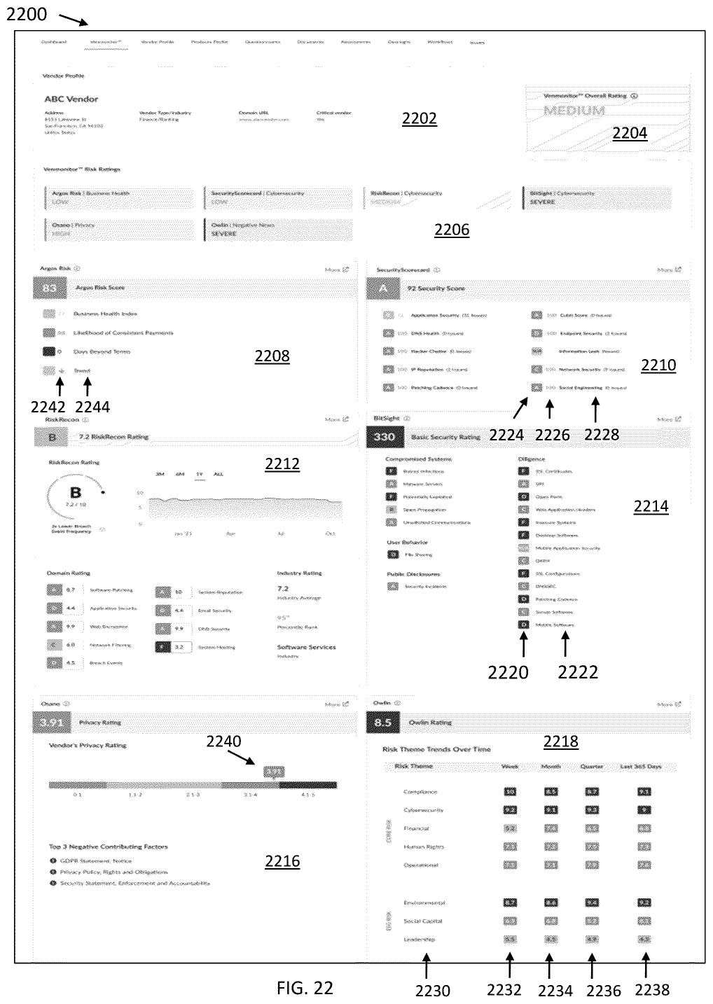

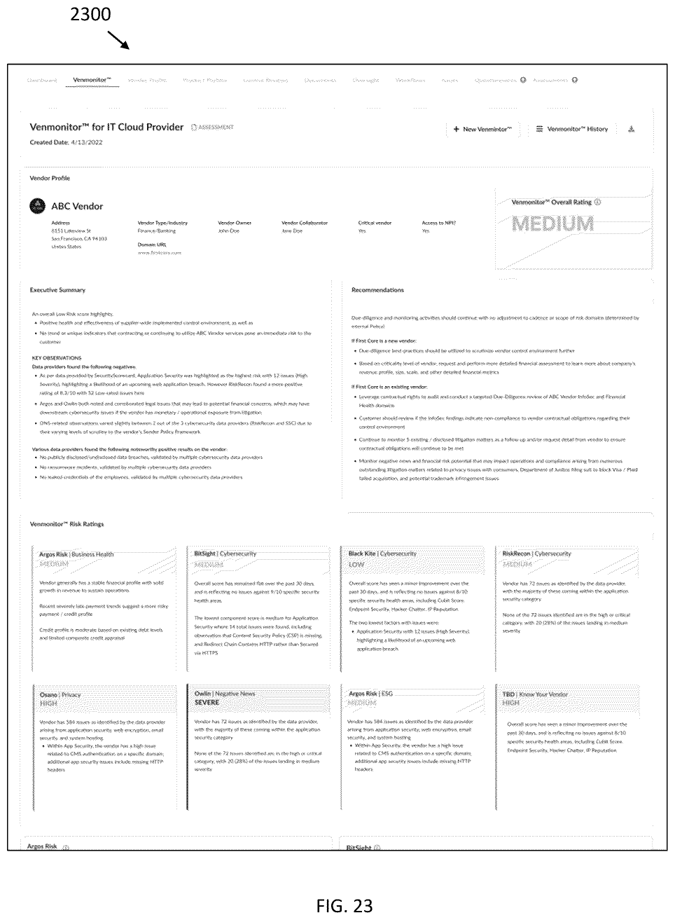

FIG. 22 illustrate example Daily Refresh and One-Time summaries 2200, in accordance with an embodiment of the invention. The Daily Refresh and One-Time summaries 2200 bring together various leading data providers across risk domains to provide insight into the risk profile of a vendor/supplier in an aggregate risk snapshot. Within this single summary view, the Daily Refresh and One-Time summaries 2200 provide clients with a high-level view into the risks a vendor/supplier may pose to an organization across key risk domains, such as cybersecurity, privacy, environmental, social and governance (“ESG”), business health and credit risk, and negative news/adverse media screening. The data may be retrieved on-demand as a one-time pull or refreshed on a daily cycle to ensure the latest data is presented to the user. The Daily Refresh and One-Time summaries 2200 may include a widget with key vendor data 2202 (for example, including address, website, industry, and status) as well as the overall risk rating 2204. The Daily Refresh and One-Time summaries 2200 may also include a risk ratings widget 2206 that includes the risk categories for the vendor in question from each of the individual data partners.

Referring still to FIG. 22, the Daily Refresh and One-Time summaries 2200 may also include individual widgets (2208-2218) for the individual data partners. For example, the Argos risk widget 2208 provides a business health rating (for example, on a scale of 0-100). The SecurityScorecard risk widget 2210 provides a cybersecurity rating (for example, also on a scale of 0-100). The RiskRecon widget 2212 provides a cybersecurity rating on a scale from 0 to 10. The BitSight widget 2214 provides a cybersecurity rating on a scale from 300-830. The Osano widget 2216 provides a privacy rating on a scale from 0 to 5. The Owlin widget 2218 provides a negative news rating on a scale of 0 to 10. Each of the Security Scorecard risk widget 2210 and the RiskRecon widget 2212 provide a score in terms of a letter grade, while the others all provide a numerical score (albeit, using a variety of numerical ranges, as described herein). The data partners include ratings in a number of sub-categories, and many include the ratings, as trended over time. The Daily Refresh and One-Time summaries 2200 aggregate all of the disparate forms of data into a single vendor risk rating score 2204.

FIG. 23 is an example One-Time Executive Summary 2300, in accordance with an embodiment of the invention. The One-Time Executive Summary 2300 may include an assessment performed by Venminder's team of subject matter experts (SME). One-Time Executive Summary 2300 includes perspective on overall risk score drivers, highest-rated category risks, risk themes across data partners, as well as recommended actions to consider for both new and existing vendor product/services.

### Email Notifications

In some embodiments, the Venmonitor module 502 may create notifications (e.g., automatically, e.g., by automatically generating and/or sending one or more email messages) when certain activities occur to alert one or more responsible individuals. Example emails and their respective triggers are shown in Table 4. As described in FIG. 4, if a drop (especially a sudden and/or dramatic drop) in a vendor overall risk rating occurs (i.e., as determined by the Venmonitor module 502), several downstream actions, notifications, and/or events could automatically be triggered. For example, in some embodiments, if a vendor overall risk rating drops by one or more level (i.e., from low risk to medium risk, from medium risk to high risk, and/or from high risk to severe risk), one or more of the following actions may automatically be triggered: additional oversight tasks may be required; a questionnaire may be sent to gather more information; advanced workflows may be launched; the user may be prompted to visit the data partner portal for additional insights (i.e., and the user may be provided with a deep link directly to the data partner value that resulted in the drop in risk rating); additional persons at the organization (i.e., at the client organization) may be notified via email (i.e., the matter is escalated); the contract management team and/or a subset of team members may be notified that contract terms should be evaluated in view of the risk rating drop. Other actions, workflows, tasks, and/or notifications may also be triggered when a drop in overall vendor risk rating occurs, according to aspects of the present embodiments. For example, in some embodiments, when a new vendor onboarding request is made, a Venmonitor One-time risk rating summary is automatically ordered and executed, according to the present embodiments, such that additional risk information can be used in connection with the decision to approve the potential new vendor. In some embodiments, if a data partner is unresponsive, a notification may be sent to the client and/or to Venminder administrators indicating that the data partner is unresponsive and optionally sending a deep link to the data partner portal (i.e., to a register location or net address allocated to the vendor of interest). For example, a system generated email may be sent to the administrator or internal “Data Partner Manager” when a data partner is not responsive in providing the requested data. The email may also be triggered when be an order in the Fulfillment Queue that has been sitting for a predetermined number of days without delivery, because one or more data points are missing. The email serves as an escalation trigger for our internal team to reach out to the data provider (i.e., data partner) to resolve the issue.

TABLE 4
Email Notifications

| Email Template | Description | Trigger |
|---|---|---|
| Vendor Provisioning | Vendor needs to be provisioned to | Client enables Venmonitor |
| Required | one or more data partner portfolios | offering |
| Vendor Request | Vendor does not exist in the data | Venmonitor module does not |
| to Data Partner | partner vendor library and a request | find API to add vendor to data |
| | must be submitted to the partner to | partner portfolio |
| | collect data | |
| API Endpoint | One or more API endpoints has | Venmonitor module |
| Failure | failed | recognizes that vendor could |
| | | not be added to data partner |
| | | portfolio |
| Vendor | A drop in vendor overall risk rating | Drop in vendor overall |
| rating drop | triggers one of many potential | risk rating |
| | downstream actions | |
| Data Partner | If a data partner is unresponsive | Data partner |
| Unresponsive | when a call to the data partner is | unresponsive |
| | made, a notification is sent | |

According to aspects of the present embodiments, the number of aggregators (i.e., data aggregators or data partners) per vendor may vary and may be pre-defined by the number of data partners selected when building a purchase plan, as described herein. In some embodiments, a client may have only one data partner if the client wises to focus on a single risk domain. In some embodiments, a client may enable all available data partners in order to achieve the most comprehensive risk assessment possible. In some embodiments, clients may utilize more than 10 data partners for assessing a single vendor. In some embodiments, clients may choose exactly how many and which data partners to utilize (i.e., an “a la carte” selection).

According to aspects of the present embodiments, the number of data points that are collected and presented in the Venmonitor module 502 for each data partner/vendor combination may vary from about 2-5 data points to more than 20 data points (as illustrated via the various Figures described herein). For example, the following data partners may include the following numbers of data points for a given vendor for each snap-shot of time at which risk is being assessed: Argos Risk: 5; SecurityScorecard: 11; RiskRecon: 15; Black Kite: 10; BitSight: 21; Osano: 2; Owlin: 9; Argos Risk ESG: 5.

According to aspects of the present embodiments, a client will have the potential to monitor the risk (i.e., via the Venmonitor module 502) for all vendors that they monitor within Venminder. This number may vary from less than ten, to tens to thousands of vendors. There is no technical limit to the number of vendors that a client can monitor. According to aspects of the present embodiments, the systems described herein are able to accommodate the data and vendor monitoring needs for in excess of 1000 different clients. According to aspects of the present embodiments, data partner data is generally refreshed once per day (i.e., every 24-hours) but can also be refreshed at different time intervals as well (i.e., more frequently (for example, on demand) if requested by the client, as well as less frequently (for example, weekly, monthly, quarterly, or yearly) as the client needs demand). In some embodiments, data partners update their vendor data at different frequencies. For example, news- based aggregators, such as Owlin, may update their vendor information as more news becomes available. However, Venminder will refresh data on a regularly scheduled 24-hour cycle for its daily refresh offering.

According to aspects of the present embodiments, communications and data transmittals between Venminder (i.e., the Venmonitor portal or module 502) and each of the data partners is done primarily via API. On an as needed basis, communications and data transmittals may also occur via telecommunications such as phone an email. In some embodiments, the data partners are aware of any calls that the Venmonitor module 502 makes to the data vendor portal. According to aspects of the present embodiments, data partner data usage is recorded by the Venmonitor module 502. According to aspects of the present embodiments, data movement between the data partners and the Venmonitor module 502 is initiated by the Venmonitor module 502.

According to aspects of the present embodiments, the data presented on Venmonitor 502 from a data partner will be a 1:1 match to data also present in the data partner's portal. The data format pulled from each data partner is preserved in the same “shape” as presented in the API. For example, the data summaries present in Venmonitor 502, as illustrated in the accompanying figures mirror the data structures of the underlying data partners. In some embodiments, Venminder creates and stores (i.e., via the Venmonitor module 502) a configuration unique to each data partner that contains conversion rules so that the data partner rating can be normalized for calculation of the overall rating across all data partners on Venmonitor.

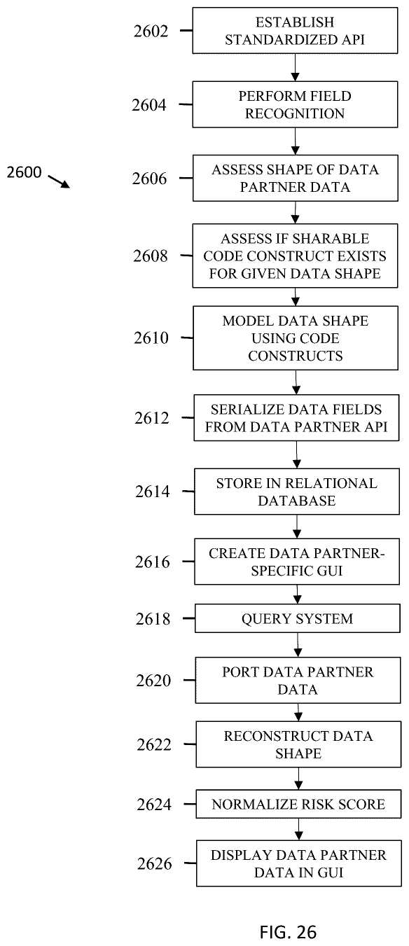

FIG. 26 illustrates a method 2600 by which data of differing shapes can be extracted from data partners for storage and display in Venmonitor (via the Venmonitor module 502), according to aspects of the present embodiments. In some embodiments, the method 2600 may be used in connection with steps 1210, 1218, and/or 1220 (as well as other potential steps) shown in FIG. 12. For example, at step 2602, the method 2600 may include establishing a standardized API for each data partner. In some embodiments, the standardized API may include a REST (representational state transfer) API. If a standardized API is already available, or alternatively, if standard data fields among varying or different APIs have been established, it may be possible to skip to step 2612 of the method 2600 (for example, because steps 2604-2610 may all be performed in order to establish an API in connection with step 2602). At step 2604, the method 2600 may include performing field recognition on the data partner data (for example, identifying how many and what types of data fields are included in the data partner data). In some embodiments, field recognition may be performed automatically via a text recognition service. In some embodiments, the text recognition service may include optical character recognition (OCR) (for example, on the data field descriptors). In some embodiments, the text recognition service may include using an image recognition query (for example, to identify data fields in the data partner API). In some embodiments, an image recognition query may be used to identify and/or classify a data structure and/or data shape of the data partner data. In some embodiments, performing field recognition on the data partner data (or API) includes using metadata (for example, via a .winmd extension file) to match fields between the data partner API and the Venmonitor API. In some embodiments, each of the data partner API and the Venmonitor API may include and/or use common language infrastructure (CLI) thereby facilitating data field matching therebetween. For example, when common names are used (i.e., in the metadata of each of the data partner API and the Venmonitor API) fields may be auto-mapped therebetween (for example, by caching the common field name or identifier for later use (at step 2610) when the data shape of the original data partner data is modeled using code constructs).

Referring still to FIG. 26, at step 2606, the method 2600 may include assessing the shape of the data partner data. The data partner data may include or be arranged in several different types of data shapes or data structures including (but not limited to) graphical data (for example, as shown in the linear scale 2240 in the Osano summary 2216 in FIG. 22, as well as in the graphical risk timeline shown at the top of the RiskRecon summary 2212), hierarchical or tree data, XML data, CSV data, linked lists, data stacks, data queues, arrays (such as the data array of risk ratings over time shown in the Owlin summary 2218 in FIG. 22), and/or JSON (JavaScript Object Notation) data formats, among other potential data structures. Even once a data structure type is identified, an exact data shape should be assessed. For example, the data array 2218 in the Owlin summary includes a first column of data with a risk theme (or risk category) 2230, and then a second, third, fourth, and fifth columns of data 2232, 2234, 2236, 2238 with a numerical risk rating for the week, month, quarter, and last 365 days respectively. In addition, the array 2218 includes 8 rows of data corresponding to the eight (8) risk categories. All of these attributes of the array 2218 need to be captured in the data shape. In another example, the BitSight summary 2214 includes a first data column 2220 with a risk grade (i.e., letter grade) and a second data column 2222 with a risk category. The Argos summary 2208 is similar in the sense that the data structure includes two columns of data 2242, 2244. However, in the Argos summary 2208 the data shape includes a first column 2242 with a numerical score (i.e., rather than a letter grade), and a second column 2244 with a risk category. In another example, the SecurityScorecard summary 2210 in FIG. 22 shows a first data column 2224 with a letter grade (for example, from A to F), a second column 2226 with a numerical score (for example, from 1-100), and a third column 2228 that includes a risk category. (The RiskRecon summary 2212 includes a similar data structure to that of the SecurityScorecard summary 2210, but differs in that the numerical value in the second column ranges from 0 to 10 instead of 0 to 100).

Still referring to FIG. 26, at step 2608 the method 2600 includes assessing if a shareable code construct exists for the given data shape (i.e., determined at step 2608). Even if a code construct does not exist for an identical data structure as the data partner in question, a similar code construct may still be useable. For example, a code construct for the Argos Risk summary 2208 may be shareable with the BitSight summary 2214 since they both include two columns of data (and the numerical risk rating in the first column would simply have to be changed to a letter grade in order to be useable for the BitSight data structure). Similarly, even though the data structures and/or shapes vary between the SecurityScorecard summary 2210 and the Risk Recon summary 2212, they are similar enough that a code structure may be sharable therebetween (and then edited accordingly so as to enable an exact matching of the data structure and data shape of the data partner data). If a sharable code construct does not exist for a given data structure or shape (i.e., because a new data partner is being on-boarded, for example, and uses a unique data structure), then a code construct may be created.

At step 2610 the method 2600 includes modeling the shape of the data partner data using code constructs. The code constructs may enable modeling the data via data pairs that use identifiers to define the location within the original data structure of one or more values in each data pair. For example, in the Owlin summary 2218 shown in FIG. 22, the data shape includes an array or matrix with 5 columns (2230, 2232, 2234, 2236, 2238) and 8 rows of data. Each entry can be represented as a data pair. For example, the first numerical entry (column 2232) in the first row (i.e., corresponding to the “compliance” category) is a numerical value of 10. Each of the values in this data pair can be appended or concatenated to include location identifier information. For example, “compliance” can be concatenated to “compliance_1_1” signifying that at row 1, column 1 (i.e., column 2230), the data value is “compliance.” Similarly, the value of 10 can be concatenated to 10_1_2 signifying that in column 2 (i.e., column 2232) of the first row, the table includes a numerical value of 10. In another example, the third column (i.e., column 2234) of the first row (i.e., the compliance row) includes a numerical value of 8.5, which can be concatenated to 8.5_1_3. Each of these examples can then be arranged as pairs with the first pair being compliance 1_1:10_1_2 and the second pair being compliance 1 1:8.5_1_3, the pairs being separated by a colon and each data identifier within the concatenation being separated by an underscore. A concatenation function such as “concatenate([table entry], “_”,[row #],“_”,[column #])” can be used to concatenate the table data with the corresponding data structure location, with underscores used as separators to signify separation between values. Using a similar approach, each of the summaries shown in FIG. 22 can be represented via data pairs, regardless of the underlying data structure or data type. By way of example, to represent a tree or hierarchical data structure using data pairs, the identifiers can be used to signify relational information about how each entry relates (i.e., within the hierarchy) to other entries in the tree, (i.e., instead of using the identifiers for location within a matrix). Identifiers can similarly be used to identify the type of data (i.e., numerical, letter grade, category description, etc.) as well as other attributes about the data.

Referring still to FIG. 26, once the data structure has been modeled using data pairs, at step 2612, the method may include serializing the data fields (for example, in a JSON format). Using the first row of the Owlin summary 2218 as an example, the serialized data fields may look like:

{
“compliance_1_1”: “10_1_2”,
“compliance_1_1”: “8.5_1_3”,
“compliance_1_1”: “8.7_1_4”,
“compliance_1_1”: “9.1_1_5”,
}

where: each of the lines are separated by a common, the two table entries in each pair are separated by a colon, each of the concatenations are within quotation marks, and each of the location identifiers within each concatenation are separated via separators (such as underscores). In some embodiments, other types of separators and syntax can be used, but care must be taken, for example, not to use a period when numerical data in decimal form is included in the table data lest the period be mistaken for a decimal, and vice versa. At step 2614, the method 2600 may include storing the serialized data pairs in a relational database. At step 2616, the method 2600 may include creating a data partner specific GUI that includes data fields that replicate the data structures and data shapes to that of the original data partner data.

Still referring to FIG. 26, once the data partner data has been stored in a relational database and a data partner specific GUI has been created, at step 2618, the method 2600 may include querying the system to retrieve the data partner data to populate the data partner specific GUI with. In some embodiments, querying the system at step 2618 includes making a call to the relational data base where serialized data partner data is stored in data pairs. In some embodiments, querying the system at step 2618 may include making a call directly to the source of the data partner data (via API that was created for that data partner), in some cases using deep linking, as described herein. In some embodiments, Venmonitor module 502 queries the data partner source data (i.e., using the API that was created for each data partner and using deep linking) once per day and updates the relational database therewith, and then the latest data partner data can be ported to the data partner specific GUI on an on-demand basis whenever the client executes a system query. In some embodiments, the client may be interested in older data partner data, in which case the system retrieves the desired data set, which is archived in the relational database, and displays it within the data partner specific GUI. At step 2620, the method 2600 may include porting the data partner data (either from the relational database or directly from the data partner data source) to the data partner specific GUI.

Referring still to FIG. 26, at step 2622, the method 2600 may include reconstructing the shape of the data partner data such that it matches its original shape. The original data partner data shape may be reconstructed by unpacking the concatenated strings of each data pair by parsing out the data table data and the location identifiers. In some embodiments, parsing the data may include using a substring function to define the start and end positions of each substring and/or by using separators to extract each concatenated string into a separate string. For example, using a substring function, “compliance_1_1” can be separated into three separate strings including “compliance” followed by “1” and “1”, signifying that the word “compliance” should be placed in the table at row 1, column 1. In this case, the substring function operates by identifying each underscore (“_”) as both the end of the current sub string as well as the beginning of a new substring. In some embodiments, parsing the data may include using a split function such as string.prototype.split( ) which separates a string into individual substrings (for example, an ordered list of substrings) by using separators (in this case, underscores). In some embodiments, the ordered list of substrings may be arranged in an array (i.e., with the same shape as the original array) by making using of the location identifiers, as described herein. Stated otherwise, the serialized data pairs (i.e., full strings) can be parsed into separate substrings such that the original data shape may be reconstructed, by leveraging the information stored in the location identifiers.

Still referring to FIG. 26, at step 2624, the method 2600 may include normalizing the risk scores for each of the ported data points such that data from different rating scales may be provided and displayed using a common rating scale, as disclosed herein. At step 2626, the method 2600 may include displaying the data partner data in the GUI (i.e., the data partner specific GUI). In some embodiments, the data partner data in its original format (i.e., not normalized) is displayed in the data partner specific GUI (with the normalized score being displayed elsewhere). In some embodiments, the normalized data partner data is displayed in the data partner specific GUI.

According to aspects of the present embodiments, each of the points of data provided by the data partners may be procured via deep-linking (i.e., a deep link established between the Venmonitor module 502 risk rating (or other) field in question and the source data in the data partner portal). In embodiments where clients already have contracted relationships with a data provider, they may input their API token in Venminder's System Settings. Therefore, clients do not need to establish a second contractual relationship nor pay additional subscription feeds to access data partner data in the Venmonitor portal 502 if they already have a subscription. The Venmonitor portal (or module) 502 allows clients to leverage their existing subscription credentials, as shown in FIG. 18B. This functionality is already enabled for multiple data partners described herein and including (but not limited to) Argos Risk, SecurityScorecard, and BitSight. In some embodiments, this functionality is enabled for all of the available data partners. In some embodiments, if the client does not have its own contractual relationship and/or token enabling access to the data partner data, a sharable token may be used in connection with the Venmonitor portal 502 to enable the access. In some embodiments, a sharable token includes a static token (that is, the Venmonitor token is reused for each client call to the data partner). In some embodiments, a shareable token includes a dynamic token that includes at least two components including the original authentication credentials (i.e., allowing Venmonitor to access the data partner data) as well as an additional component that verifies that the client has been authenticated by the Venmonitor module or portal 502 (i.e., via the login process of the client into Venmonitor).

The present embodiments enable data from multiple data partners (i.e., third parties) to be accessed by a client via a single portal, and facilitate the identification of the data partner data shape, the transformation of the data partner data into serialized data pairs which may be ported to a relational database remote from the data partner, the normalization of the data partner data into a standardized format, the reconstruction of the data partner data (i.e., either the original data or the normalized data) in its original shape, and the displaying of the data in the single portal. In accordance with the present embodiments, programming languages such as JavaScript, C++, Visual Basic, Python, Fortran, Ruby, Java, SQL, and other common languages may be used.

In the absence of the present embodiments, it would be technically possible for a person to gather all the data from the data partners for each vendor, and perform a manual aggregation of the risk scores. However, this would prove costly and/or impossible, both in time and money. The person would be required to contract with each data partner to gain access to partner portals to provision vendors (which includes both a financial cost, and a time cost). The individual would be required to access each portal to gather data and may be required to reach out to different points of contact when there are issues. Additional headcount would likely be required to maintain those relationships. In addition, the sheer number of vendors, data partners per vendor, data points per data partner, and frequency at which each of the data points are refreshed for the average client make this process practically infeasible. Moreover, given the disparate rating scales for each data partner, the data normalization and risk averaging processes are far from simple. By leveraging Venmonitor, the client is enabled to maintain only one contract and a single point of contact (Venminder) for issues. Given that a multitude of vendors have already been provisioned, the time needed to request Venmonitor and to deliver data will be significantly less in comparison to trying to produce the same results “manually.” Moreover, the data partner data can be transformed into serialized data pairs, regardless of its original data shape, to facilitate porting and storing of the data, and can then be reconstructed for display in its original shape.

### Exemplary Network Environment and Computing Device

FIG. 24 shows an illustrative network environment 3400 for use in the methods and systems described herein. In brief overview, referring now to FIG. 24, a block diagram of an exemplary cloud computing environment 3400 is shown and described. The cloud computing environment 3400 may include one or more resource providers 3402a, 3402b, 3402c (collectively, 3402). Each resource provider 3402 may include computing resources. In some implementations, computing resources may include any hardware and/or software used to process data. For example, computing resources may include hardware and/or software capable of executing algorithms, computer programs, and/or computer applications. In some implementations, exemplary computing resources may include application servers and/or databases with storage and retrieval capabilities. Each resource provider 3402 may be connected to any other resource provider 3402 in the cloud computing environment 3400. In some implementations, the resource providers 3402 may be connected over a computer network 3408. Each resource provider 3402 may be connected to one or more computing device 3404a, 3404b, 3404c (collectively, 3404), over the computer network 3408.

The cloud computing environment 3400 may include a resource manager 3406. The resource manager 3406 may be connected to the resource providers 3402 and the computing devices 3404 over the computer network 3408. In some implementations, the resource manager 3406 may facilitate the provision of computing resources by one or more resource providers 3402 to one or more computing devices 3404. The resource manager 3406 may receive a request for a computing resource from a particular computing device 3404. The resource manager 3406 may identify one or more resource providers 3402 capable of providing the computing resource requested by the computing device 3404. The resource manager 3406 may select a resource provider 3402 to provide the computing resource. The resource manager 3406 may facilitate a connection between the resource provider 3402 and a particular computing device 3404. In some implementations, the resource manager 3406 may establish a connection between a particular resource provider 3402 and a particular computing device 3404. In some implementations, the resource manager 3406 may redirect a particular computing device 3404 to a particular resource provider 3402 with the requested computing resource.

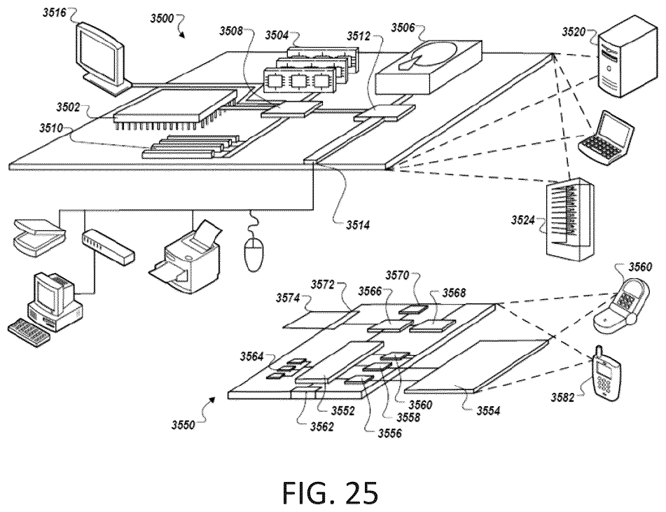

FIG. 25 shows an example of a computing device 3500 and a mobile computing device 3550 that can be used in the methods and systems described in this disclosure. The computing device 3500 is intended to represent various forms of digital computers, such as laptops, desktops, workstations, personal digital assistants, servers, blade servers, mainframes, and other appropriate computers. The mobile computing device 3550 is intended to represent various forms of mobile devices, such as personal digital assistants, cellular telephones, smart-phones, and other similar computing devices. The components shown here, their connections and relationships, and their functions, are meant to be examples only, and are not meant to be limiting.

The computing device 3500 includes a processor 3502, a memory 3504, a storage device 3506, a high-speed interface 3508 connecting to the memory 3504 and multiple high-speed expansion ports 3510, and a low-speed interface 3512 connecting to a low-speed expansion port 3514 and the storage device 3506. Each of the processor 3502, the memory 3504, the storage device 3506, the high-speed interface 3508, the high-speed expansion ports 3510, and the low-speed interface 3512, are interconnected using various busses, and may be mounted on a common motherboard or in other manners as appropriate. The processor 3502 can process instructions for execution within the computing device 3500, including instructions stored in the memory 3504 or on the storage device 3506 to display graphical information for a GUI on an external input/output device, such as a display 3516 coupled to the high-speed interface 3508. In other implementations, multiple processors and/or multiple buses may be used, as appropriate, along with multiple memories and types of memory. Also, multiple computing devices may be connected, with each device providing portions of the necessary operations (e.g., as a server bank, a group of blade servers, or a multi-processor system).

The memory 3504 stores information within the computing device 3500. In some implementations, the memory 3504 is a volatile memory unit or units. In some implementations, the memory 3504 is a non-volatile memory unit or units. The memory 3504 may also be another form of computer-readable medium, such as a magnetic or optical disk.

The storage device 3506 is capable of providing mass storage for the computing device 3500. In some implementations, the storage device 3506 may be or contain a computer-readable medium, such as a floppy disk device, a hard disk device, an optical disk device, or a tape device, a flash memory or other similar solid state memory device, or an array of devices, including devices in a storage area network or other configurations. Instructions can be stored in an information carrier. The instructions, when executed by one or more processing devices (for example, processor 3502), perform one or more methods, such as those described above. The instructions can also be stored by one or more storage devices such as computer- or machine-readable mediums (for example, the memory 3504, the storage device 3506, or memory on the processor 3502).

The high-speed interface 3508 manages bandwidth-intensive operations for the computing device 3500, while the low-speed interface 3512 manages lower bandwidth-intensive operations. Such allocation of functions is an example only. In some implementations, the high-speed interface 3508 is coupled to the memory 3504, the display 3516 (e.g., through a graphics processor or accelerator), and to the high-speed expansion ports 3510, which may accept various expansion cards (not shown). In the implementation, the low-speed interface 3512 is coupled to the storage device 3506 and the low-speed expansion port 3514. The low-speed expansion port 3514, which may include various communication ports (e.g., USB, Bluetooth®, Ethernet, wireless Ethernet) may be coupled to one or more input/output devices, such as a keyboard, a pointing device, a scanner, or a networking device such as a switch or router, e.g., through a network adapter.

The computing device 3500 may be implemented in a number of different forms, as shown in the figure. For example, it may be implemented as a standard server 3520, or multiple times in a group of such servers. In addition, it may be implemented in a personal computer such as a laptop computer 3522. It may also be implemented as part of a rack server system 3524. Alternatively, components from the computing device 3500 may be combined with other components in a mobile device (not shown), such as a mobile computing device 3550. Each of such devices may contain one or more of the computing device 3500 and the mobile computing device 3550, and an entire system may be made up of multiple computing devices communicating with each other.

The mobile computing device 3550 includes a processor 3552, a memory 3564, an input/output device such as a display 3554, a communication interface 3566, and a transceiver 3568, among other components. The mobile computing device 3550 may also be provided with a storage device, such as a micro-drive or other device, to provide additional storage. Each of the processor 3552, the memory 3564, the display 3554, the communication interface 3566, and the transceiver 3568, are interconnected using various buses, and several of the components may be mounted on a common motherboard or in other manners as appropriate.

The processor 3552 can execute instructions within the mobile computing device 3550, including instructions stored in the memory 3564. The processor 3552 may be implemented as a chipset of chips that include separate and multiple analog and digital processors. The processor 3552 may provide, for example, for coordination of the other components of the mobile computing device 3550, such as control of user interfaces, applications run by the mobile computing device 3550, and wireless communication by the mobile computing device 3550.

The processor 3552 may communicate with a user through a control interface 3558 and a display interface 3556 coupled to the display 3554. The display 3554 may be, for example, a TFT (Thin-Film-Transistor Liquid Crystal Display) display or an OLED (Organic Light Emitting Diode) display, or other appropriate display technology. The display interface 3556 may comprise appropriate circuitry for driving the display 3554 to present graphical and other information to a user. The control interface 3558 may receive commands from a user and convert them for submission to the processor 3552. In addition, an external interface 3562 may provide communication with the processor 3552, so as to enable near area communication of the mobile computing device 3550 with other devices. The external interface 3562 may provide, for example, for wired communication in some implementations, or for wireless communication in other implementations, and multiple interfaces may also be used.

The memory 3564 stores information within the mobile computing device 3550. The memory 3564 can be implemented as one or more of a computer-readable medium or media, a volatile memory unit or units, or a non-volatile memory unit or units. An expansion memory 3574 may also be provided and connected to the mobile computing device 3550 through an expansion interface 3572, which may include, for example, a SIMM (Single In Line Memory Module) card interface. The expansion memory 3574 may provide extra storage space for the mobile computing device 3550, or may also store applications or other information for the mobile computing device 3550. Specifically, the expansion memory 3574 may include instructions to carry out or supplement the processes described above, and may include secure information also. Thus, for example, the expansion memory 3574 may be provided as a security module for the mobile computing device 3550, and may be programmed with instructions that permit secure use of the mobile computing device 3550. In addition, secure applications may be provided via the SIMM cards, along with additional information, such as placing identifying information on the SIMIVI card in a non-hackable manner.

The memory may include, for example, flash memory and/or NVRAM memory (non-volatile random access memory), as discussed below. In some implementations, instructions are stored in an information carrier and, when executed by one or more processing devices (for example, processor 3552), perform one or more methods, such as those described above. The instructions can also be stored by one or more storage devices, such as one or more computer- or machine-readable mediums (for example, the memory 3564, the expansion memory 3574, or memory on the processor 3552). In some implementations, the instructions can be received in a propagated signal, for example, over the transceiver 3568 or the external interface 3562.

The mobile computing device 3550 may communicate wirelessly through the communication interface 3566, which may include digital signal processing circuitry where necessary. The communication interface 3566 may provide for communications under various modes or protocols, such as GSM voice calls (Global System for Mobile communications), SMS (Short Message Service), EMS (Enhanced Messaging Service), or MMS messaging (Multimedia Messaging Service), CDMA (code division multiple access), TDMA (time division multiple access), PDC (Personal Digital Cellular), WCDMA (Wideband Code Division Multiple Access), CDMA2000, or GPRS (General Packet Radio Service), among others. Such communication may occur, for example, through the transceiver 3568 using a radio-frequency. In addition, short-range communication may occur, such as using a Bluetooth®, Wi-Fi™, or other such transceiver (not shown). In addition, a GPS (Global Positioning System) receiver module 3570 may provide additional navigation- and location-related wireless data to the mobile computing device 3550, which may be used as appropriate by applications running on the mobile computing device 3550.

The mobile computing device 3550 may also communicate audibly using an audio codec 3560, which may receive spoken information from a user and convert it to usable digital information. The audio codec 3560 may likewise generate audible sound for a user, such as through a speaker, e.g., in a handset of the mobile computing device 3550. Such sound may include sound from voice telephone calls, may include recorded sound (e.g., voice messages, music files, etc.) and may also include sound generated by applications operating on the mobile computing device 3550.

The mobile computing device 3550 may be implemented in a number of different forms, as shown in the figure. For example, it may be implemented as a cellular telephone 3580. It may also be implemented as part of a smart-phone 3582, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms machine-readable medium and computer-readable medium refer to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term machine-readable signal refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (LAN), a wide area network (WAN), and the Internet.

The computing system can include clients and servers. A client and server are generally remote from each other and typically interact through a communication network. The relationship of client and server arises by virtue of computer programs running on the respective computers and having a client-server relationship to each other.

EQUIVALENTS

It is to be understood that while the disclosure has been described in conjunction with the detailed description thereof, the foregoing description is intended to illustrate and not limit the scope of the invention(s). Other aspects, advantages, and modifications are within the scope of the claims.

This written description uses examples to disclose the invention, including the best mode, and also to enable any person skilled in the art to practice the present embodiments, including making and using any devices or systems and performing any incorporated methods. The patentable scope of the present embodiments is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A vendor monitoring system comprising:
a vendor monitoring portal identifying at least one vendor of interest; and
at least one data partner portal communicatively coupled to the vendor monitoring portal, the at least one data partner portal controlled by a third party data partner, the at least one data partner portal providing at least one risk rating to the vendor monitoring portal, the at least one risk rating associated with the at least one vendor of interest.

2. The system of claim 1, comprising multiple data partners, wherein each data partner provides at least one risk rating associated with the vendor of interest to the vendor monitoring portal.

3. The system of claim 2, wherein each data partner provides a risk assessment based on at least one aspect of risk, the at least one aspect of risk comprising cybersecurity, privacy, business health, negative news, dark web risks, and/or environmental, social, and/or governance (ESG).

4. The system of claim 3, wherein the multiple data partners provide risk assessments to the vendor monitoring based on cybersecurity, privacy, business health, and negative news.

5. The system of claim 1, wherein the vendor monitoring portal is deep-linked to the data partner portal.

6. The system of claim 1, wherein the vendor monitoring portal communicates with the data partner portal via at least one application programmable interface (API).

7. The system of claim 2, wherein data from each data partner, once received by the vendor monitoring portal, is normalized to a standard risk rating scale.

8. The system of claim 7, wherein the data from each data partner, once normalized, is aggregated to arrive at a single overall risk rating for the vendor of interest.

9. The system of claim 8, wherein the data from each data partner, once normalized, is aggregated via arithmetic averaging to arrive at the single overall risk rating for the vendor of interest.

10. The system of claim 2, wherein the vendor monitoring portal accesses data from about 4 to about 10 data partners, and
wherein the vendor monitoring portal accesses data from the each of the data partners once every 24 hours.

11. The system of claim 2, wherein the vendor monitoring portal accesses cybersecurity risk data from more than one data partner.

12. A method of reconstructing an original shape of third party data, the method comprising:
accessing, by a client within a single portal, the third party data via an API call to the third party;
identifying a shape of the third party data;
transforming the third party data into serialized data pairs;
porting the serialized data pairs to a relational database, the relational database being remote from the third party; and
reconstructing the third party data in the original shape within at least one client graphical user interface (GUI).

13. The method of claim 12, further comprising displaying the third party data in the original shape within the at least one client GUI within the single portal.

14. The method of claim 13, wherein reconstructing an original shape of third party data comprises reconstructing respective original shapes of data from multiple third parties, the method further comprising normalizing data from the multiple third parties to a standardized numerical rating scale.

15. The method of claim 12, wherein identifying a shape of the third party data comprises performing field recognition within an API of the third party.

16. The method of claim 12, wherein transforming the third party data into serialized data pairs comprises concatenating the third party data with at least one location identifier and at least one separator into a single string.

17. The method of claim 12, wherein reconstructing the third party data in the original shape comprises parsing the serialized data pairs into a series of substrings comprising at least one original data point from the third party data and at least one location identifier.

18. The method of claim 12, wherein accessing, by a client within a single portal, the third party data comprises using, by the client, at least one sharable token.

19. The method of claim 12, wherein accessing, by a client within a single portal, the third party data comprises matching a first field of a client API to a second field of a third party API,
wherein each of the first field and the second field comprises guaranteed unique evidence.

20. The method of claim 12, wherein the respective original shapes of data from multiple third parties comprises at least one third party data shape that is different from at least one other third party data shape; and
wherein transforming the third party data into serialized data pairs comprises transforming the third party data into JavaScript Object Notation (JSON) data format.
